(19) United States
(12) Patent Application Publication
(10) Pub. No.: US 2025/0150234 A1
(43) Pub. Date: May 8, 2025

(54) MINI SLOT CONFIGURATIONS FOR SIDELINK POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/836,723

(22) PCT Filed: Mar. 22, 2023
(86) PCT No.: PCT/US2023/064823

§ 371 Date: Aug. 7, 2024

(30) Foreign Application Priority Data
Apr. 26, 2022 (GR) 20220100337

(51) Int. Cl. H04L 5/00; H04W 72/40

(52) U.S. Cl. CPC H04L 5/0051; H04W 72/40

(57) ABSTRACT

Disclosed are systems, apparatuses, processes, and computer-readable media for wireless communications. For example, an example of a process for performing sidelink positioning at a user equipment (UE) includes receiving, at the UE, a resource block including a plurality of sidelink symbols in a slot. The slot includes a plurality of slot portions. For instance, a first slot portion of the plurality of slot portions may include at least a first sidelink symbol with at least a first sidelink positioning reference signal (SL-PRS) resource and a second slot portion of the plurality of slot portions may include at least a second sidelink symbol with at least a second SL-PRS resource. The process may further include processing, by the UE, at least one SL-PRS resource in each of the plurality of slot portions of the slot.

### CROSS-REFERENCE TO RELATED APPLICATIONS

This application for patent is a 371 of international Patent Application PCT/US2023/064823, filed Mar. 22, 2023, which claims priority to Greek patent application Ser. No. 20/220,100337, filed Apr. 26, 2022, all of which are hereby incorporated by referenced in their entirety and for all purposes.

### FIELD

The present disclosure generally relates to sidelink positioning. For example, aspects of the present disclosure relate to mini slot configurations for sidelink (SL) positioning.

### BACKGROUND

Wireless communication systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users with, for example, a gigabit connection speeds to tens of users in a common location, such as on an office floor. Several hundreds of thousands of simultaneous connections should be supported in order to support large sensor deployments. Consequently, the spectral efficiency of 5G mobile communications should be significantly enhanced compared to the current 4G/LTE standard. Furthermore, signaling efficiencies should be enhanced and latency should be substantially reduced compared to current standards.

### SUMMARY

Systems and techniques are described herein that provide mini slot configurations for sidelink positioning with wireless communication systems. According to one illustrative example, a method for performing sidelink positioning at a user equipment (UE) is provided. The method includes: receiving, at the UE, a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and processing, by the UE, at least one SL-PRS resource in each of the plurality of slot portions of the slot.

In another illustrative example, an apparatus is provided for performing sidelink positioning, including at least one memory and at least one processor (e.g., configured in circuitry) coupled to the at least one memory. The at least one processor configured to: receive a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and process at least one SL-PRS resource in each of the plurality of slot portions of the slot.

In another illustrative example, at least one non-transitory computer-readable medium is provided having instructions which, when executed by one or more processors, cause the one or more processors to: receive a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and process at least one SL-PRS resource in each of the plurality of slot portions of the slot.

In another illustrative example, an apparatus is provided including: means for receiving a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and means for processing at least one SL-PRS resource in each of the plurality of slot portions of the slot.

According to another illustrative example, a method for performing sidelink positioning at a first user equipment (UE) is provided. The method includes: generating, at the first UE, a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and transmitting, from the first UE, the resource block to a second UE.

In another illustrative example, an apparatus for performing sidelink positioning is provided including at least one memory and at least one processor (e.g., configured in circuitry) coupled to the at least one memory. The at least one processor is configured to: generate a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and transmit the resource block to a user equipment (UE).

In another illustrative example, at least one non-transitory computer-readable medium is provided having instructions which, when executed by one or more processors, cause the one or more processors to: generate a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and transmit the resource block to a user equipment (UE).

In another illustrative example, an apparatus is provided including: means for generating a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and means for transmitting the resource block to a user equipment (UE).

In some aspects, the apparatus is, is part of, and/or includes a UE, such as a wearable device, an extended reality (XR) device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A is a diagram illustrating an example wireless communications system, in accordance with some aspects of the present disclosure.

FIG. 1B is a diagram illustrating an example of a disaggregated base station architecture, which may be employed by the disclosed system for providing mini slots for sidelink positioning with wireless communication systems, in accordance with some examples.

FIGS. 2A and 2B are diagrams illustrating example wireless network structures, in accordance with some aspects of the present disclosure.

FIG. 3 is a block diagram illustrating an example of a computing system of a vehicle, in accordance with some aspects of the present disclosure.

FIG. 4 illustrates an example block diagram of a computing system of a UE, in accordance with some aspects of the present disclosure.

FIG. 5 is a diagram illustrating an example of devices involved in wireless communications (e.g., sidelink communications), in accordance with some aspects of the present disclosure.

FIG. 6 is a diagram illustrating an example of a resource block.

FIG. 7 is a diagram illustrating examples of existing comb structures for reference signals.

FIG. 8 is a diagram illustrating an example of a resource block for sidelink positioning, according to some aspects of the present disclosure.

FIG. 9A is diagram illustrating an example of a system for providing mini slots for sidelink positioning, where UEs assign positioning resources from a resource pool for positioning, according to some aspects of the present disclosure.

FIG. 9B is diagram illustrating an example of a system for providing mini slots for sidelink positioning, where a base station assigns positioning resources from a resource pool for positioning, according to some aspects of the present disclosure.

FIG. 10A is a diagram illustrating an example of a slot structure including mini slots having control channels that are not frequency division multiplexed with positioning resources, according to some aspects of the present disclosure.

FIG. 10B is a diagram illustrating an example of a slot structure including mini slots having control channels that are frequency division multiplexed with positioning resources, according to some aspects of the present disclosure.

FIG. 11A is a diagram illustrating an example of a slot structure including mini slots having a control channel resource within each mini slot, according to some aspects of the present disclosure.

FIG. 11B is a diagram illustrating an example of a slot structure including mini slots sharing a single control channel resource across the mini slots, according to some aspects of the present disclosure.

FIG. 11C is a diagram illustrating an example of a slot structure including mini slots without any control channel resource, according to some aspects of the present disclosure.

FIG. 12A is a diagram illustrating an example of a slot structure including three mini slots, according to some aspects of the present disclosure.

FIG. 12B is a diagram illustrating an example of a slot structure including two mini slots, according to some aspects of the present disclosure.

FIG. 12C is a diagram illustrating an example of slot structures of two slots, according to some aspects of the present disclosure.

FIG. 13A is diagram illustrating an example of a system for providing mini slots for sidelink positioning, where a UE assigns specific mini slots for transmission to other UEs, according to some aspects of the present disclosure.

FIG. 13B is diagram illustrating an example of a system for providing mini slots for sidelink positioning, where a base station assigns a specific mini slot for a UE to transmit to another UE, according to some aspects of the present disclosure.

FIG. 13C is diagram illustrating an example of a system for providing mini slots for sidelink positioning, where a base station instructs a UE to use a slot including mini slots to transmit to another UE, according to some aspects of the present disclosure.

FIG. 13D is a diagram illustrating an example of a slot structure including mini slots that may be employed by the systems of FIGS. 13A, 13B, and 13C, according to some aspects of the present disclosure.

FIG. 14A is a diagram illustrating an example of a slot structure including mini slots having gaps such that the mini slots are separated by a gap, according to some aspects of the present disclosure.

FIG. 14B is a diagram illustrating an example of a slot structure including mini slots without gaps, according to some aspects of the present disclosure.

FIG. 15 is a flow chart illustrating an example of a process for wireless communications, according to some aspects of the present disclosure.

FIG. 16 is a flow chart illustrating another example of a process for wireless communications, according to some aspects of the present disclosure.

FIG. 17 illustrates an example computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted above, 5G mobile standard calls for higher data transfer speeds, greater numbers of connections, and better coverage, among other improvements. 5G is expected to support several hundreds of thousands of simultaneous connections. Consequently, there is room to improve the spectral efficiency of 5G mobile communications by enhancing signaling efficiencies and reducing latency. One aspect where such signaling efficiency and reduction in latency could be achieved is by employing mini slots for transmissions of reference signals, such as positioning reference signals (PRSs), sounding reference signals (SRSs), etc., for positioning (e.g., sidelink positioning).

Sidelink positioning utilizes reference signals (e.g., PRSs) to obtain a position of a UE with respect to other objects, such as other UEs. In particular, sidelink positioning utilizes a round-trip time (RTT) measurement of a positioning reference signal (PRS). For example, when two UEs desire to position themselves with respect to one another, the UEs each transmit a PRS and each measure the RTT of their respective transmitted signal. From the measured RTT, each of the UEs can determine their distance from one another and position themselves accordingly.

Reference signals (e.g., PRSs) are predefined signals occupying specific resource elements (REs) within a time-frequency grid of a resource block (e.g., a slot) and may be exchanged on one or both of downlink and uplink physical communication channels. Each type of reference signal has been defined by the 3rd Generation Partnership Project (3GPP) for a specific purpose, such as for channel estimation, phase-noise compensation, acquiring downlink/uplink channel state information, time and frequency tracking, among others. In particular, PRSs have been defined by the 3GPP as downlink specific signals to be used for positioning purposes.

In 5G NR, a slot is the typical unit for transmission used by scheduling mechanisms. A 5G NR slot typically occupies either fourteen (for normal cyclic prefix (CP)) or twelve (for extended CP) orthogonal frequency division multiplexing (OFDM) symbols, which enable slot based scheduling. A slot is a scheduling unit, and the aggregation of slots is allowed for scheduling purposes. The length of a slot may be scaled with the subcarrier spacing. 5G NR specifies that transmissions may start at any OFDM symbol of a slot, and to last only as many symbols as required for the communications.

5G NR time division duplexing (TDD) employs a flexible slot configuration, where the OFDM symbols in a slot can be classified as “downlink”, “uplink”, or “flexible.” Flexible symbols can be configured either for uplink or downlink transmissions. If a slot configuration is not provided (e.g., by the network), all of the symbols in the slot are considered to be flexible by default. In 5G NR, the configuration of the slot format can be done in a static, semi-static, or fully dynamic fashion. Static and semi-static slot configurations are performed using radio resource control (RRC), while dynamic slot configurations are performed using physical downlink control channel (PDCCH) downlink control information (DCI).

A mini slot is a portion of a slot, and is the minimum scheduling unit used in 5G NR. A mini slot can also be referred to herein as a slot portion. A mini slot can occupy as little as two OFDM symbols, and can be variable in length (e.g. occupying two, four, or seven OFDM symbols). Mini slots can be positioned asynchronously with respect to the beginning of a standard slot. The use of mini slots allows for very low latency for critical data communications as well as the minimization of interference to other radio frequency (RF) links. Mini slots enable “non-slot based scheduling” that has a higher priority than normal enhanced mobile broadband (eMBB) transmissions and, thus, mini slots can preempt other eMBB transmissions. As such, the use of mini-slots helps to achieve lower latency in the 5G NR architecture.

Systems, apparatuses, processes (also referred to as methods), and computer-readable media (collectively referred to herein as systems and techniques) are described herein for providing mini slot configurations (also referred to as slot portion configurations) for sidelink positioning with wireless communication systems. In one or more aspects, a resource block, which may be referred to as a “slot,” may include a plurality of symbols. The slot may be divided into two or more mini slots or slot portions. At least one symbol of each mini slot may include a reference signal (e.g., PRS) resource, such as a transmit (Tx) PRS resource or a receive (Rx) PRS resource. These mini slots containing PRS resources may be employed for sidelink positioning for providing very low latency for the system.

In one or more aspects, for a first mode (e.g., mode 1) of operation of the disclosed system, a UE (e.g., a mobile phone, an XR device, a vehicle, etc.) may generate a resource block made up of fourteen or twelve OFDM symbols in a slot. A group of the symbols may include reference signal resources, such as PRS resources. The UE may generate the resource block so that the slot is segmented into a plurality of mini slots including the reference signal (e.g., PRS) resources. The UE may transmit the generated resource block to another UE in sidelink communications (e.g., for sidelink positioning). In some aspects, for a second mode (e.g., mode 2) of operation of the disclosed system, a UE (e.g., a mobile device such as a smart phone, an XR device, or a vehicle) may receive from a network entity (e.g., a base station, such as a gNB) a resource block (e.g., made up of fourteen or twelve OFDM symbols in a slot) including a plurality of mini slots having reference signal (e.g., PRS) resources. After receiving the resource block, the UE may process the PRS resources of the resource block, and utilize the resource block for sidelink positioning.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical Transmission-Reception Point (TRP) or to multiple physical Transmission-Reception Points (TRPs) that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

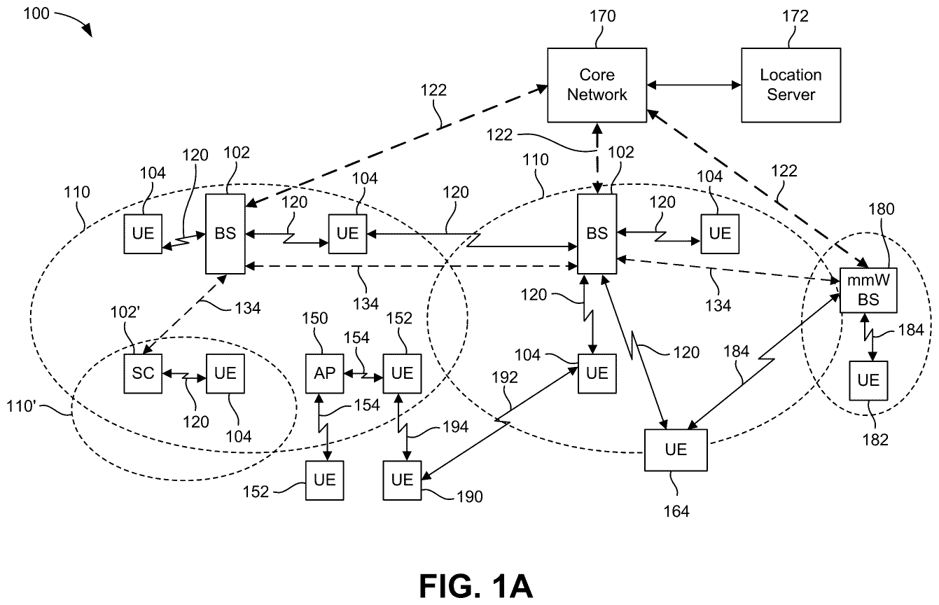

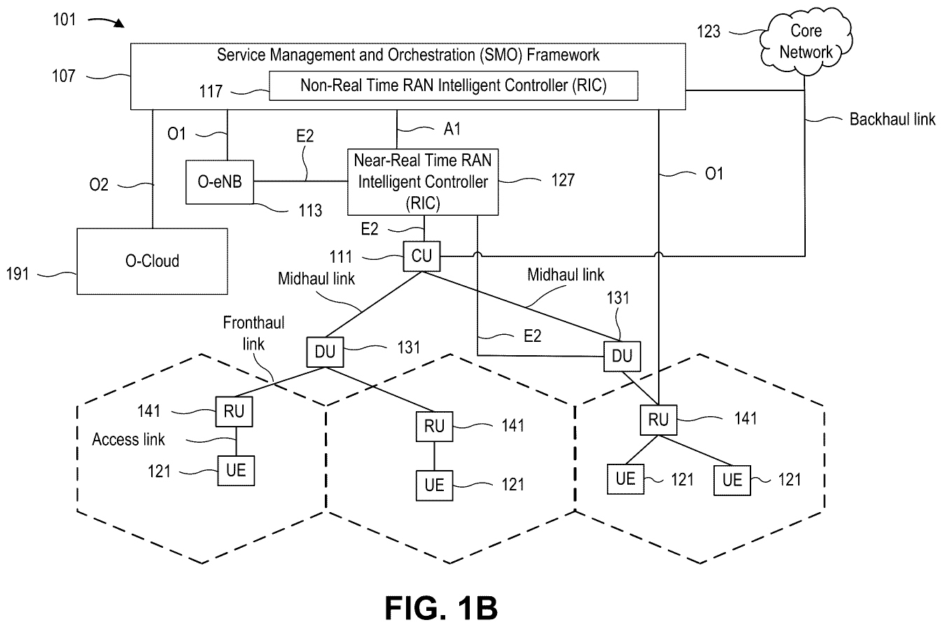

According to various aspects, FIG. 1A illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1A, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1A, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

FIG. 1B is a diagram illustrating an example of a disaggregated base station architecture, which may be employed by the disclosed system for providing mini slots for sidelink positioning with wireless communication systems, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 1B shows a diagram illustrating an example disaggregated base station 101 architecture. The disaggregated base station 101 architecture may include one or more central units (CUs) 111 that can communicate directly with a core network 123 via a backhaul link, or indirectly with the core network 123 through one or more disaggregated base station units (such as a Near-Real Time (Near-RT) RAN Intelligent Controller (RIC) 127 via an E2 link, or a Non-Real Time (Non-RT) RIC 117 associated with a Service Management and Orchestration (SMO) Framework 107, or both). A CU 111 may communicate with one or more distributed units (DUs) 131 via respective midhaul links, such as an F1 interface. The DUs 131 may communicate with one or more radio units (RUs) 141 via respective fronthaul links. The RUs 141 may communicate with respective UEs 121 via one or more RF access links. In some implementations, the UE 121 may be simultaneously served by multiple RUs 141.

Each of the units, i.e., the CUS 111, the DUs 131, the RUs 141, as well as the Near-RT RICs 127, the Non-RT RICs 117 and the SMO Framework 107, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 111 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 111. The CU 111 may be configured to handle user plane functionality (i.e., Central Unit-User Plane (CU-UP)), control plane functionality (i.e., Central Unit-Control Plane (CU-CP)), or a combination thereof. In some implementations, the CU 111 can be logically split into one or more CU-UP units and one or more CU-CP units. The CU-UP unit can communicate bidirectionally with the CU-CP unit via an interface, such as the E1 interface when implemented in an O-RAN configuration. The CU 111 can be implemented to communicate with the DU 131, as necessary, for network control and signaling.

The DU 131 may correspond to a logical unit that includes one or more base station functions to control the operation of one or more RUs 141. In some aspects, the DU 131 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 131 may further host one or more low PHY layers. Each layer (or module) can be implemented with an interface configured to communicate signals with other layers (and modules) hosted by the DU 131, or with the control functions hosted by the CU 111.

Lower-layer functionality can be implemented by one or more RUs 141. In some deployments, an RU 141, controlled by a DU 131, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 141 can be implemented to handle over the air (OTA) communication with one or more UEs 121. In some implementations, real-time and non-real-time aspects of control and user plane communication with the RU(s) 141 can be controlled by the corresponding DU 131. In some scenarios, this configuration can enable the DU(s) 131 and the CU 111 to be implemented in a cloud-based RAN architecture, such as a vRAN architecture.

The SMO Framework 107 may be configured to support RAN deployment and provisioning of non-virtualized and virtualized network elements. For non-virtualized network elements, the SMO Framework 107 may be configured to support the deployment of dedicated physical resources for RAN coverage requirements which may be managed via an operations and maintenance interface (such as an O1 interface). For virtualized network elements, the SMO Framework 107 may be configured to interact with a cloud computing platform (such as an open cloud (O-Cloud) 191) to perform network element life cycle management (such as to instantiate virtualized network elements) via a cloud computing platform interface (such as an O2 interface). Such virtualized network elements can include, but are not limited to, CUs 111, DUs 131, RUs 141 and Near-RT RICs 127. In some implementations, the SMO Framework 107 can communicate with a hardware aspect of a 4G RAN, such as an open eNB (O-eNB) 113, via an O1 interface. Additionally, in some implementations, the SMO Framework 107 can communicate directly with one or more RUs 141 via an O1 interface. The SMO Framework 107 also may include a Non-RT RIC 117 configured to support functionality of the SMO Framework 107.

The Non-RT RIC 117 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 127. The Non-RT RIC 117 may be coupled to or communicate with (such as via an A1 interface) the Near-RT RIC 127. The Near-RT RIC 127 may be configured to include a logical function that enables near-real-time control and optimization of RAN elements and resources via data collection and actions over an interface (such as via an E2 interface) connecting one or more CUs 111, one or more DUs 131, or both, as well as an O-eNB 113, with the Near-RT RIC 127.

In some implementations, to generate AI/ML models to be deployed in the Near-RT RIC 127, the Non-RT RIC 117 may receive parameters or external enrichment information from external servers. Such information may be utilized by the Near-RT RIC 127 and may be received at the SMO Framework 107 or the Non-RT RIC 117 from non-network data sources or from network functions. In some examples, the Non-RT RIC 117 or the Near-RT RIC 127 may be configured to tune RAN behavior or performance. For example, the Non-RT RIC 117 may monitor long-term trends and patterns for performance and employ AI/ML models to perform corrective actions through the SMO Framework 107 (such as reconfiguration via 01) or via creation of RAN management policies (such as A1 policies).

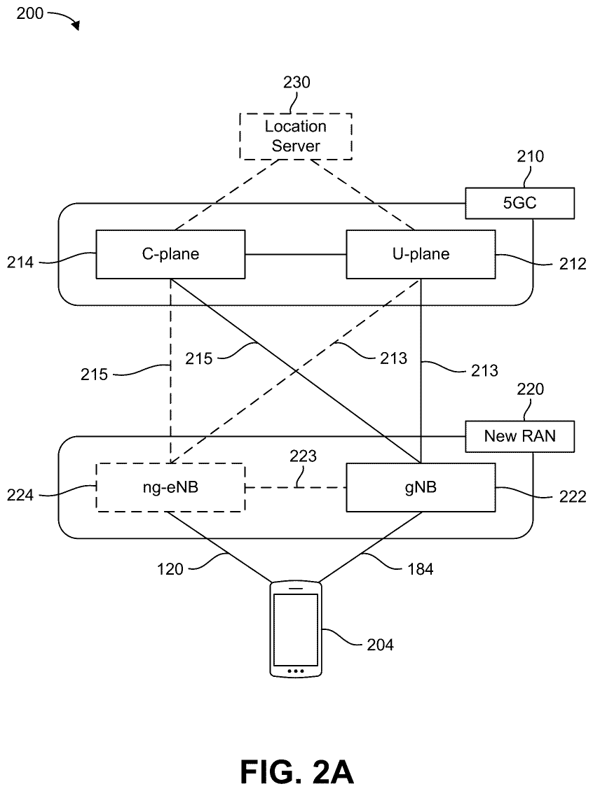

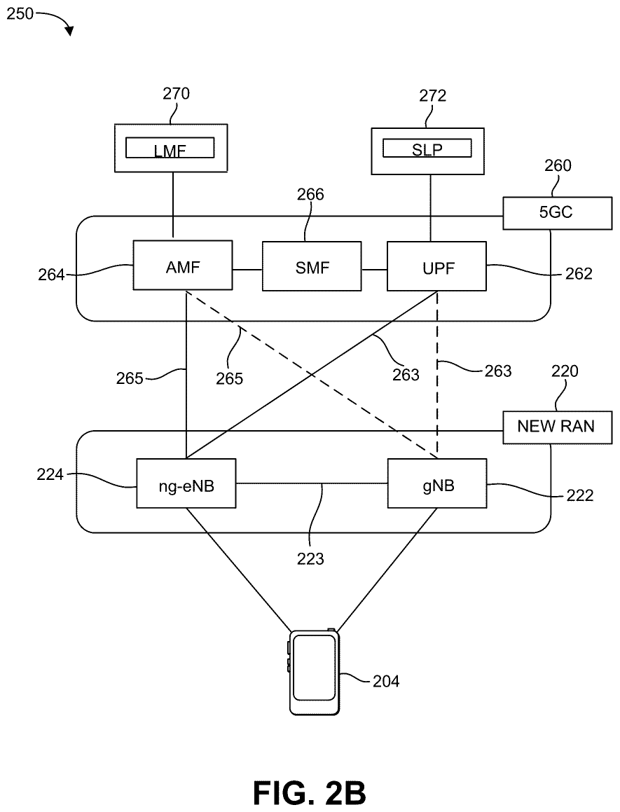

According to various aspects, FIG. 2A illustrates an example wireless network structure 200. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1A).

Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated with a component of the core network, or alternatively may be external to the core network. In some examples, the location server 230 can be operated by a carrier or provider of the 5GC 210, a third party, an original equipment manufacturer (OEM), or other party. In some cases, multiple location servers can be provided, such as a location server for the carrier, a location server for an OEM of a particular device, and/or other location servers. In such cases, location assistance data can be received from the location server of the carrier and other assistance data can be received from the location server of the OEM.

According to various aspects, FIG. 2B illustrates another example wireless network structure 250. For example, a 5GC 260 can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1A). The network nodes or network entities (e.g., base stations) of the New RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and/or security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 also supports functionalities for non-3GPP access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink and/or downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

In some aspects, location and positioning functions can be aided by a Location Management Function (LMF) 270 that is configured for communication with the 5GC 260, e.g., to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

In an aspect, the LMF 270 and/or the SLP 272 may be integrated with a network node or entity (e.g., base station), such as the gNB 222 and/or the ng-eNB 224. When integrated with the gNB 222 and/or the ng-eNB 224, the LMF 270 and/or the SLP 272 may be referred to as a “location management component,” or “LMC.” However, as used herein, references to the LMF 270 and the SLP 272 include both the case in which the LMF 270 and the SLP 272 are components of the core network (e.g., 5GC 260) and the case in which the LMF 270 and the SLP 272 are components of a network node or entity (e.g., base station).

As discussed herein, NR supports a number of cellular network-based positioning technologies, including downlink-based, uplink-based, and downlink-and-uplink-based positioning methods. For example, the LMF 270 can enable positioning based on location measurements computed for various positioning signal (PRS or SRS) resources. As used herein, “PRS resource set” is a set of PRS resources used for the transmission of PRS signals, where each PRS resource has a PRS resource identifier (ID). In addition, the PRS resources in a PRS resource set are associated with the same TRP. A PRS resource set is identified by a PRS resource set ID and is associated with a particular TRP (e.g., identified by a TRP ID). In addition, the PRS resources in a PRS resource set have the same periodicity, a common muting pattern configuration, and the same repetition factor (e.g., PRS-ResourceRepetitionFactor) across slots. The periodicity is the time from the first repetition of the first PRS resource of a first PRS instance to the same first repetition of the same first PRS resource of the next PRS instance. The periodicity may have a length selected from 2^{μ}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

In some cases, a PRS resource ID in a PRS resource set is associated with a single beam (and/or beam ID) transmitted from a single TRP (where a TRP may transmit one or more beams). For example, each PRS resource of a PRS resource set may be transmitted on a different beam, and as such, a “PRS resource,” or simply “resource,” can also be referred to as a “beam.” Note that this does not have any implications on whether the TRPs and the beams on which PRS are transmitted are known to the UE.

A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance,” a “positioning occasion,” “a positioning instance,” a “positioning repetition,” or simply an “occasion,” an “instance,” or a “repetition.”

A “positioning frequency layer” (also referred to simply as a “frequency layer” or “layer”) is a collection of one or more PRS resource sets across one or more TRPs that have the same values for certain parameters. Specifically, the collection of PRS resource sets has the same subcarrier spacing (SCS) and cyclic prefix (CP) type (meaning all numerologies supported for the PDSCH are also supported for PRS), the same Point A, the same value of the downlink PRS bandwidth, the same start PRB (and center frequency), and the same comb size. The Point A parameter takes the value of the parameter ARFCN-ValueNR (where “ARFCN” stands for “absolute radio-frequency channel number”) and is an identifier and/or code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one network node or entity (e.g., a base station, or a macro cell base station and a small cell base station) to transmit data channels, while frequency layers are used by several (usually three or more) a network nodes or entities (e.g., base stations) to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Downlink-based location measurements can include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., PRS, TRS, NRS, CSI-RS, SSB, etc.) received from pairs of network nodes or entities (e.g., base stations), referred to as reference signal time difference (RSTD) or time difference of arrival (TDOA) measurements, and reports them to a positioning entity. More specifically, the UE receives the identifiers of a reference network node or entity (e.g., a serving base station) and multiple non-reference network nodes or entities (e.g., base stations) in assistance data. The UE then measures the RSTD between the reference network node or entity (e.g., reference base station) and each of the non-reference network nodes or entities (e.g., non-reference base stations). Based on the known locations of the involved network nodes/entities (e.g., base stations) and the RSTD measurements, the positioning entity (e.g., LMF 270) can estimate the UE's location. For DL-AoD positioning, a network node or entity (e.g., a base station such as gNB 222) measures the angle and other channel properties (e.g., signal strength) of the downlink transmit beam used to communicate with a UE to estimate the location of the UE.

Uplink-based positioning methods include uplink time difference of arrival (UL-TDOA) and uplink angle-of-arrival (UL-AoA). UL-TDOA is similar to DL-TDOA, but is based on uplink reference signals (e.g., SRS) transmitted by the UE. For UL-AoA positioning, a network node or entity (e.g., a base station) measures the angle and other channel properties (e.g., gain level) of the uplink receive beam used to communicate with a UE to estimate the location of the UE.

Downlink-and-uplink-based positioning methods include enhanced cell-ID (E-CID) positioning and multi-round-trip-time (RTT) positioning (also referred to as “multi-cell RTT or multi RTT”). In an RTT procedure, an initiator (a network node or entity, such as a base station, or a UE) transmits an RTT measurement signal (e.g., a PRS or SRS) to a responder (a UE or base station), which transmits an RTT response signal (e.g., an SRS or PRS) back to the initiator. The RTT response signal includes the difference between the ToA of the RTT measurement signal and the transmission time of the RTT response signal, referred to as the reception-to-transmission (Rx-Tx) measurement. The initiator calculates the difference between the transmission time of the RTT measurement signal and the ToA of the RTT response signal, referred to as the “Tx-Rx” measurement. The propagation time (also referred to as the “time of flight”) between the initiator and the responder can be calculated from the Tx-Rx and Rx-Tx measurements. Based on the propagation time and the known speed of light, the distance between the initiator and the responder can be determined. For multi-RTT positioning, a UE performs an RTT procedure with multiple network nodes or entities (e.g., base stations) to enable its location to be determined (e.g., using multilateration) based on the known locations of the a network nodes (e.g., base stations). RTT and multi-RTT methods can be combined with other positioning techniques, such as UL-AoA and DL-AoD, to improve location accuracy.

To assist positioning operations, a location server (e.g., location server 230, LMF 270, or other location server) may provide assistance data to the UE. For example, the assistance data may include identifiers of the network nodes or entities (e.g., base stations or the cells and/or TRPs of the base stations) from which to measure reference signals, the reference signal configuration parameters (e.g., the number of consecutive positioning subframes, periodicity of positioning subframes, muting sequence, frequency hopping sequence, reference signal ID, reference signal bandwidth, etc.), and/or other parameters applicable to the particular positioning method. Alternatively, the assistance data may originate directly from the network nodes or entities (e.g., base stations) themselves, such as in periodically broadcasted overhead messages, etc. In some cases, the UE may be able to detect neighbor network nodes itself without the use of assistance data.

For DL-AoD, the UE 204 can provide DL-PRS beam RSRP measurements to the LMF 270, whereas the gNB 222 can provide the beam azimuth and elevation angle information. When using an UL AoA positioning method, the position of UE 204 is estimated based on UL SRS AoA measurements taken at different TRPs (not illustrated). For example, TRPs can report AoA measurements directly to LMF 270. Using angle information (e.g., AoD or AoA) together TRP co-coordinate information and beam configuration details, the LMF 270 can estimate a location of UE 204.

For multi-RTT location measurements, the LMF 270 can initiate a procedure whereby multiple TRPs (not illustrated) and a UE perform the gNB Rx-Tx and UE Rx-Tx measurements, respectively. For example, the gNB 222 and UE 204 can transmit a downlink positioning reference signal (DL-PRS) and uplink sounding reference signal (UL-SRS), respectively, whereby the gNB 222 configures UL-SRS to the UE 204 e.g., using the RRC protocol. In turn, the LMF 270 can provide the DL-PRS configuration to the UE 204. Resulting location measurements are reported to the LMF 270 by the UE 204 and/or gNB 222 to perform location estimation for the UE 204.

The 3rd Generation Partnership (3GPP) (e.g., Technical Specification (TS) TS22.261 and others) requires location measurements of devices (e.g., UEs) with sub-meter level performance. Conventional approaches to determining location measurements using terrestrial systems determine a distance using a “code-phase” or an RSTD measurement technique based on a time of arrival (ToA) of the signal. In one example of an RSTD measurement, a UE receives signals from several neighboring eNBs and the ToA from each eNB are subtracted from the ToA of a reference eNB to yield an observed time difference of arrival (ODToA) of each neighboring eNBs. Each ODToA determines a hyperbola based on a known function, and a point at which the hyperbolas intersect corresponds to the location of the UE. At least three different timing measurements from geographically dispersed eNBs with good geometry are needed to solve for two coordinates (e.g., latitude and longitude) of the UE. RSTD measurements cannot satisfy the requirement of location measurement with sub-meter level performance due to timing errors and location errors that propagate into each ODToA measurement and reduce the accuracy of the location measurement.

A terrestrial-based system may implement an angle of departure (AoD) method or a Zenith angle of departure (ZoD) method to provide better accuracy and resource utilization within a 3GPP system. There are contributions proposing the use of phase measurement for improving 5G/NR location measurements, however, the feasibility and performance of such proposals have not been sufficiently studied in 3GPP.

In some cases, phase measurement-based location measurements can be achieved using a non-terrestrial system, such as a Global Navigation Satellite System (GNSS), that employs carrier phase positioning techniques to provide centimeter-level accuracy. Carrier phase positioning can be performed by determining timing and/or distance measurements using a wavelength of a subcarrier signal. In contrast to RSTD measurement techniques, carrier phase positioning estimate a phase of a subcarrier signal in the frequency domain.

One example of GNSS measurement techniques that provide sub-meter level performance use real-time kinematic positioning (RTK) to improve the accuracy of current satellite navigation (e.g., GNSS based) systems by configuring a network entity (e.g., a base station such as an eNB, a gNB, etc.) to measure the subcarrier signal and the network entity retransmits the measured phase of the carrier signal to a UE. The UE also measures the phase of the carrier signal from the satellite and compares the phase measurement at the UE and the phase measurement at the network entity to determine the distance of the mobile device from the network entity. While RTK positioning provides better accuracy over conventional GNSS measurement approaches, the accuracy is limited based on the accuracy of the network entity (e.g., the base station), line-of-sight to the satellite, and environmental conditions that can affect the measurements from the satellite system. For example, buildings can create reflections that increase phase error measured by the mobile device and cloudy conditions. RTK positioning is also limited to outdoor environments due to the receiver device requiring a line-of-sight to the satellites.

Bluetooth can also use carrier phase measurement for providing centimeter-level high accuracy positioning services but is limited to indoor environments due to the limited range of Bluetooth communication. Carrier phase measurement with Bluetooth may be inaccurate because the reference devices that transmit the carrier signals may not be fixed and inaccuracies in the location of the reference devices propagate into the carrier phase measurement.

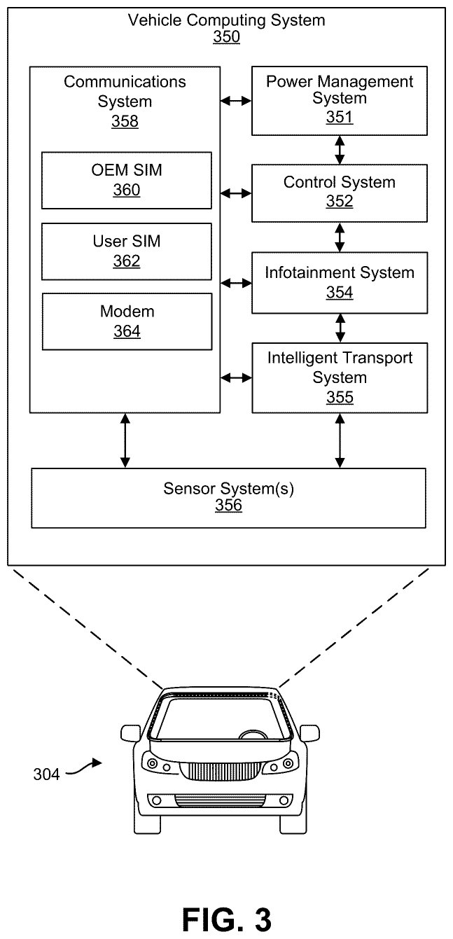

FIG. 3 is a block diagram illustrating an example a vehicle computing system 350 of a vehicle 304. The vehicle 304 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface). As shown, the vehicle computing system 350 can include at least a power management system 351, a control system 352, an infotainment system 354, an intelligent transport system (ITS) 355, one or more sensor systems 356, and a communications system 358. In some cases, the vehicle computing system 350 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 352 can be configured to control one or more operations of the vehicle 304, the power management system 351, the computing system 350, the infotainment system 354, the ITS 355, and/or one or more other systems of the vehicle 304 (e.g., a braking system, a steering system, a safety system other than the ITS 355, a cabin system, and/or other system). In some examples, the control system 352 can include one or more electronic control units (ECUs). An ECU can control one or more of the electrical systems or subsystems in a vehicle. Examples of specific ECUs that can be included as part of the control system 352 include an engine control module (ECM), a powertrain control module (PCM), a transmission control module (TCM), a brake control module (BCM), a central control module (CCM), a central timing module (CTM), among others. In some cases, the control system 352 can receive sensor signals from the one or more sensor systems 356 and can communicate with other systems of the vehicle computing system 350 to operate the vehicle 304.

The vehicle computing system 350 also includes a power management system 351. In some implementations, the power management system 351 can include a power management integrated circuit (PMIC), a standby battery, and/or other components. In some cases, other systems of the vehicle computing system 350 can include one or more PMICs, batteries, and/or other components. The power management system 351 can perform power management functions for the vehicle 304, such as managing a power supply for the computing system 350 and/or other parts of the vehicle. For example, the power management system 351 can provide a stable power supply in view of power fluctuations, such as based on starting an engine of the vehicle. In another example, the power management system 351 can perform thermal monitoring operations, such as by checking ambient and/or transistor junction temperatures. In another example, the power management system 351 can perform certain functions based on detecting a certain temperature level, such as causing a cooling system (e.g., one or more fans, an air conditioning system, etc.) to cool certain components of the vehicle computing system 350 (e.g., the control system 352, such as one or more ECUs), shutting down certain functionalities of the vehicle computing system 350 (e.g., limiting the infotainment system 354, such as by shutting off one or more displays, disconnecting from a wireless network, etc.), among other functions.

The vehicle computing system 350 further includes a communications system 358. The communications system 358 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 358 is configured to transmit and receive information wirelessly over any suitable wireless network (e.g., a 3G network, 4G network, 5G network, WiFi network, Bluetooth™ network, and/or other network). The communications system 358 includes various components or devices used to perform the wireless communication functionalities, including an original equipment manufacturer (OEM) subscriber identity module (referred to as a SIM or SIM card) 360, a user SIM 362, and a modem 364. While the vehicle computing system 350 is shown as having two SIMs and one modem, the computing system 350 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 360 can be used by the communications system 358 for establishing a wireless connection for vehicle-based operations, such as for conducting emergency-calling (eCall) functions, communicating with a communications system of the vehicle manufacturer (e.g., for software updates, etc.), among other operations. The OEM SIM 360 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 362 can be used by the communications system 358 for performing wireless network access functions in order to support a user data connection (e.g., for conducting phone calls, messaging, Infotainment related services, among others). In some cases, a user device of a user can connect with the vehicle computing system 350 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 358 the vehicle, in which case the user device can cease performance of the wireless network access functionality (e.g., during the period in which the communications system 358 is performing the wireless access functionality). The communications system 358 can begin interacting with a base station to perform one or more wireless communication operations, such as facilitating a phone call, transmitting and/or receiving data (e.g., messaging, video, audio, etc.), among other operations. In such cases, other components of the vehicle computing system 350 can be used to output data received by the communications system 358. For example, the infotainment system 354 (described below) can display video received by the communications system 358 on one or more displays and/or can output audio received by the communications system 358 using one or more speakers.

A modem is a device that modulates one or more carrier wave signals to encode digital information for transmission, and demodulates signals to decode the transmitted information. The modem 364 (and/or one or more other modems of the communications system 358) can be used for communication of data for the OEM SIM 360 and/or the user SIM 362. In some examples, the modem 364 can include a 4G (or LTE) modem and another modem (not shown) of the communications system 358 can include a 5G (or NR) modem. In some examples, the communications system 358 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 364 (and/or one or more other modems of the communications system 358) can be used for performing V2X communications (e.g., with other vehicles for V2V communications, with other devices for D2D communications, with infrastructure systems for V2I communications, with pedestrian UEs for V2P communications, etc.). In some examples, the communications system 358 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 358 can be or can include a telematics control unit (TCU). In some implementations, the TCU can include a network access device (NAD) (also referred to in some cases as a network control unit or NCU). The NAD can include the modem 364, any other modem not shown in FIG. 3, the OEM SIM 360, the user SIM 362, and/or other components used for wireless communications. In some examples, the communications system 358 can include a Global Navigation Satellite System (GNSS). In some cases, the GNSS can be part of the one or more sensor systems 356, as described below. The GNSS can provide the ability for the vehicle computing system 350 to perform one or more location services, navigation services, and/or other services that can utilize GNSS functionality.

In some cases, the communications system 358 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 304 to communicate with a network and/or other UEs.

The vehicle computing system 350 can also include an infotainment system 354 that can control content and one or more output devices of the vehicle 304 that can be used to output the content. The infotainment system 354 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 304), and/or other output device.

In some examples, the computing system 350 can include the intelligent transport system (ITS) 355. In some examples, the ITS 355 can be used for implementing V2X communications. For example, an ITS stack of the ITS 355 can generate V2X messages based on information from an application layer of the ITS. In some cases, the application layer can determine whether certain conditions have been met for generating messages for use by the ITS 355 and/or for generating messages that are to be sent to other vehicles (for V2V communications), to pedestrian UEs (for V2P communications), and/or to infrastructure systems (for V2I communications). In some cases, the communications system 358 and/or the ITS 355 can obtain car access network (CAN) information (e.g., from other components of the vehicle via a CAN bus). In some examples, the communications system 358 (e.g., a TCU NAD) can obtain the CAN information via the CAN bus and can send the CAN information to a PHY/MAC layer of the ITS 355. The ITS 355 can provide the CAN information to the ITS stack of the ITS 355. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 355.

The conditions used to determine whether to generate messages can be determined using the CAN information based on safety-related applications and/or other applications, including applications related to road safety, traffic efficiency, infotainment, business, and/or other applications. In one illustrative example, the ITS 355 can perform lane change assistance or negotiation. For instance, using the CAN information, the ITS 355 can determine that a driver of the vehicle 304 is attempting to change lanes from a current lane to an adjacent lane (e.g., based on a blinker being activated, based on the user veering or steering into an adjacent lane, etc.). Based on determining the vehicle 304 is attempting to change lanes, the ITS 355 can determine a lane-change condition has been met that is associated with a message to be sent to other vehicles that are nearby the vehicle in the adjacent lane. The ITS 355 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 304, such as based on V2P communications with a UE of the user), traffic sign recognition, among others.

The ITS 355 can use any suitable protocol to generate messages (e.g., V2X messages). Examples of protocols that can be used by the ITS 355 include one or more Society of Automotive Engineering (SAE) standards, such as SAE J2735, SAE J2945, SAE J3161, and/or other standards, which are hereby incorporated by reference in their entirety and for all purposes.

A security layer of the ITS 355 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 355 can be signed by the security layer of the ITS 355. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 355 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 352) to perform automatic functions, such as automatic breaking, automatic steering (e.g., to maintain a heading in a particular lane), automatic lane change negotiation with other vehicles, among other automatic functions. In one illustrative example, a message can be received by the communications system 358 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 352, which can cause the control system 352 to automatically break the vehicle 304 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 355 can receive a large number of messages from the other UEs (e.g., vehicles, RSUs, etc.), in which case the ITS 355 will authenticate (e.g., decode and decrypt) each of the messages and/or determine which operations to perform. Such a large number of messages can lead to a large computational load for the vehicle computing system 350. In some cases, the large computational load can cause a temperature of the computing system 350 to increase. Rising temperatures of the components of the computing system 350 can adversely affect the ability of the computing system 350 to process the large number of incoming messages. One or more functionalities can be transitioned from the vehicle 304 to another device (e.g., a user device, a RSU, etc.) based on a temperature of the vehicle computing system 350 (or component thereof) exceeding or approaching one or more thermal levels. Transitioning the one or more functionalities can reduce the computational load on the vehicle 304, helping to reduce the temperature of the components. A thermal load balancer can be provided that enable the vehicle computing system 350 to perform thermal based load balancing to control a processing load depending on the temperature of the computing system 350 and processing capacity of the vehicle computing system 350.

The computing system 350 further includes one or more sensor systems 356 (e.g., a first sensor system through an Nth sensor system, where N is a value equal to or greater than 0). When including multiple sensor systems, the sensor system(s) 356 can include different types of sensor systems that can be arranged on or in different parts the vehicle 304. The sensor system(s) 356 can include one or more camera sensor systems, light or sound-based sensors such as a depth sensor using any suitable technology for determining depth (e.g., based on time-of-flight (ToF), structured light, or light-based depth sensing technique or system), Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 350 of the vehicle 304.

While the vehicle computing system 350 is shown to include certain components and/or systems, one of ordinary skill will appreciate that the vehicle computing system 350 can include more or fewer components than those shown in FIG. 3. For example, the vehicle computing system 350 can also include one or more input devices and one or more output devices (not shown). In some implementations, the vehicle computing system 350 can also include (e.g., as part of or separate from the control system 352, the infotainment system 354, the communications system 358, and/or the sensor system(s) 356) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

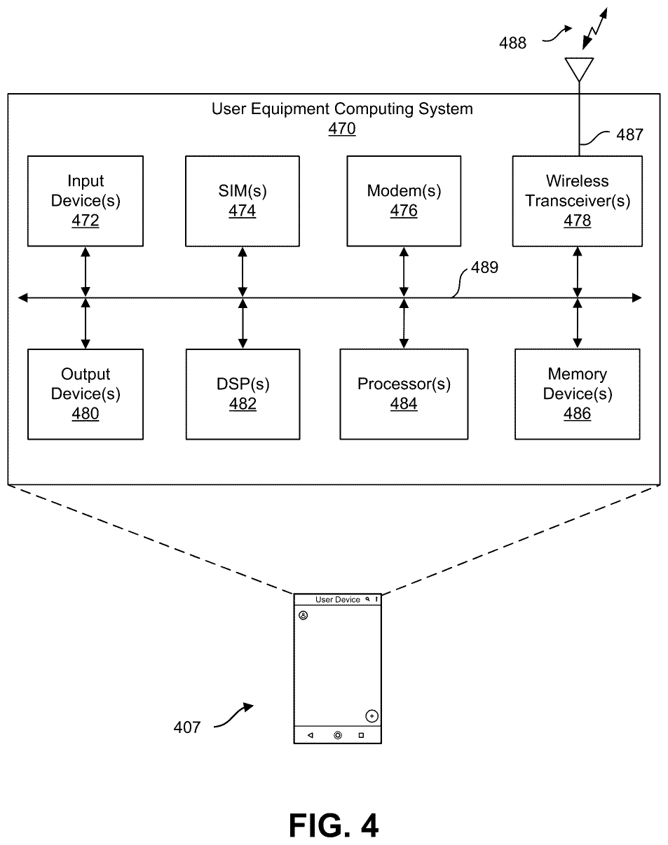

FIG. 4 illustrates an example of a computing system 470 of a user equipment (UE) 407. In some examples, the UE 407 can include a mobile phone, router, tablet computer, laptop computer, tracking device, wearable device (e.g., a smart watch, glasses, an XR device, etc.), Internet of Things (IoT) device, and/or other device used by a user to communicate over a wireless communications network. The computing system 470 includes software and hardware components that can be electrically coupled via a bus 489 (or may otherwise be in communication, as appropriate). For example, the computing system 470 includes one or more processors 484. The one or more processors 484 can include one or more CPUs, ASICs, FPGAs, APs, GPUs, VPUs, NSPs, microcontrollers, dedicated hardware, any combination thereof, and/or other processing device or system. The bus 489 can be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like). As used herein, the one or more wireless transceivers 478 can include one or more receiving devices (e.g., receivers) and/or one or more transmitting devices (e.g., transmitters).

The one or more wireless transceivers 478 can transmit and receive wireless signals (e.g., signal 488) via antenna 487 to and from one or more other devices, such as one or more other UEs, network nodes or entities (e.g., base stations such as eNBs and/or gNBs, WiFi routers, etc.), cloud networks, and/or the like. As described herein, the one or more wireless transceivers 478 can include a combined transmitter/receiver, discrete transmitters, discrete receivers, or any combination thereof. In some examples, the computing system 470 can include multiple antennae. The wireless signal 488 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 478 may include a radio frequency (RF) front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 488 into a baseband or intermediate frequency and can convert the RF signals to the digital domain.

In some cases, the computing system 470 can include a coding-decoding device (or CODEC) configured to encode and/or decode data transmitted and/or received using the one or more wireless transceivers 478. In some cases, the computing system 470 can include an encryption-decryption device or component configured to encrypt and/or decrypt data (e.g., according to the AES and/or DES standard) transmitted and/or received by the one or more wireless transceivers 478.

The one or more SIMs 474 can each securely store an International Mobile Subscriber Identity (IMSI) number and a related key assigned to the user of the UE 407. The IMSI and the key can be used to identify and authenticate the subscriber when accessing a network provided by a network service provider or operator associated with the one or more SIMs 474. The one or more modems 476 can modulate one or more signals to encode information for transmission using the one or more wireless transceivers 478. The one or more modems 476 can also demodulate signals received by the one or more wireless transceivers 478 in order to decode the transmitted information. In some examples, the one or more modems 476 can include a 4G (or LTE) modem, a 5G (or NR) modem, a Bluetooth™ modem, a modem configured for vehicle-to-everything (V2X) communications, and/or other types of modems. In some examples, the one or more modems 476 and the one or more wireless transceivers 478 can be used for communicating data for the one or more SIMs 474.

The computing system 470 can also include (and/or be in communication with) one or more non-transitory machine-readable storage media or storage devices (e.g., one or more memory devices 486), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 can also include software elements (e.g., located within the one or more memory devices 486), including, for example, an operating system, device drivers, executable libraries, and/or other code, such as one or more application programs, which may include computer programs implementing the functions provided by various aspects, and/or may be designed to implement methods and/or configure systems, as described herein.

In some aspects, the UE 407 can include means for performing operations described herein. The means can include one or more of the components of the computing system 470. For example, the means for performing operations described herein may include one or more of input device(s) 472, SIM(s) 474, modems(s) 476, wireless transceiver(s) 478, output device(s) 480, DSP(s) 482, processor(s) 484, memory device(s) 486, and/or antenna(s) 487.

In some aspects, the UE 407 can include means for receiving a resource block including a plurality of sidelink symbols in a slot. The slot may include a plurality of slot portions. For instance, a first slot portion of the plurality of slot portions may include at least a first sidelink symbol with at least a first sidelink positioning reference signal (SL-PRS) resource and a second slot portion of the plurality of slot portions may include at least a second sidelink symbol with at least a second SL-PRS resource. In some aspects, the UE 407 may further include means for processing at least one SL-PRS resource in each of the plurality of slot portions of the slot. The UE 407 may further include means for transmitting data, such as the first SL-PRS resource, the second SL-PRS resource, or other data or resource.

In some aspects, the UE 407 can include means for generating a resource block including a plurality of sidelink symbols in a slot. The slot may include a plurality of slot portions. Each of the plurality of slot portions of the slot may include at least one sidelink positioning reference signal (SL-PRS) resource. In some aspects, the UE 407 may further include means for transmitting the resource block to a second UE.

In some examples, the means for receiving can include the one or more wireless transceivers 478, the one or more modems 476, the one or more SIMs 474, the one or more processors 484, the one or more DSPs 482, the one or more memory devices 486, any combination thereof, or other component(s) of the client device. In some examples, the means for processing can include the one or more processors 484, the one or more DSPs 482, the one or more memory devices 486, any combination thereof, or other component(s) of the client device. In some examples, the means for transmitting can include the one or more wireless transceivers 478, the one or more modems 476, the one or more SIMs 474, the one or more processors 484, the one or more DSPs 482, the one or more memory devices 486, any combination thereof, or other component(s) of the client device.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), DSPs, central processing units (CPUs), and/or other suitable electronic circuits), and/or can include and/or be implemented using computer software, firmware, or any combination thereof, to perform the various operations described herein.

A wireless communication network may support both access links and side links for communication between wireless devices. An access link may refer to any communication link between a client device (e.g., a user equipment (UE) or other client device) and a base station (e.g., a 3GPP gNB, a 3GPP eNB, a Wi-Fi access point (AP), or other base station). For example, an access link may support uplink signaling, downlink signaling, connection procedures, etc.

A sidelink may refer to any communication link between client devices (e.g., UEs, STAs, etc.). For example, a sidelink may support device-to-device (D2D) communications, vehicle-to-everything (V2X) and/or vehicle-to-vehicle (V2V) communications, message relaying, discovery signaling, beacon signaling, or any combination of these or other signals transmitted over-the-air from one UE to one or more other UEs. Depending on the desired implementation, sidelink communications can be performed according to 3GPP communication protocols sidelink (e.g., using a PC5 sidelink interface according to LTE, 5G, etc.), Wi-Fi direct communication protocols (e.g., DSRC protocol), or using any other device-to-device communication protocol. As used herein, the term sidelink can refer to 3GPP sidelink (e.g., using a PC5 sidelink interface), Wi-Fi direct communications (e.g., according to the DSRC protocol), or using any other direct device-to-device communication protocol. In some examples, sidelink communications may be transmitted using a licensed frequency spectrum or an unlicensed frequency spectrum (e.g., 5 GHz or 6 GHz).

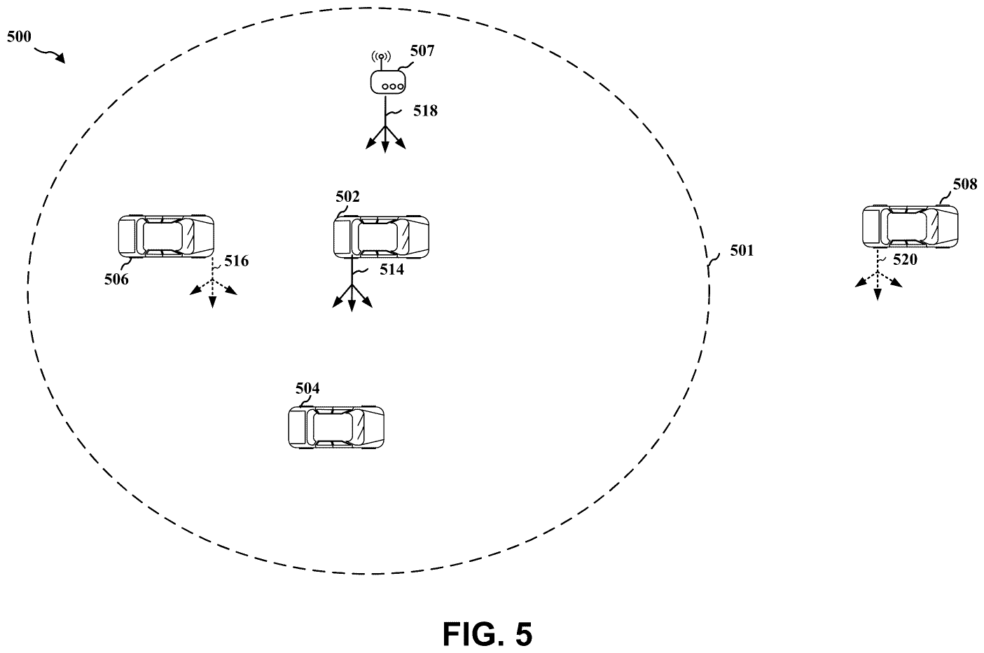

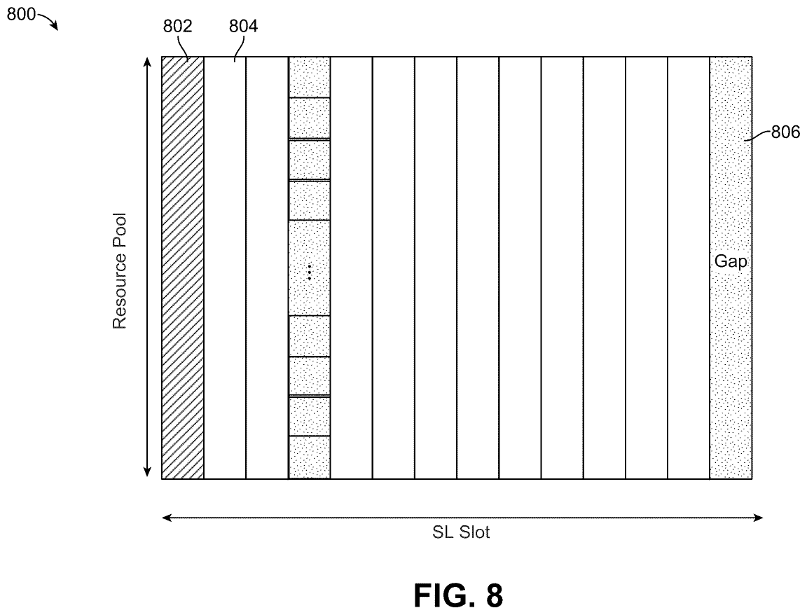

FIG. 5 illustrates an example 500 of wireless communication between devices based on sidelink communications, such as V2X or other D2D communication. The communication may be based on a slot structure (e.g., a resource block) comprising aspects described in connection with FIG. 8. For example, transmitting UE 502 may transmit a transmission 514, e.g., comprising a control channel and/or a corresponding data channel, that may be received by receiving UEs 504, 506, 508. At least one UE may include a vehicle (e.g., a ground or air-based vehicle). A control channel may include information for decoding a data channel and may also be used by receiving device to avoid interference by refraining from transmitting on the occupied resources during a data transmission. The number of TTIs, as well as the resource blocks (RBs) that will be occupied by the data transmission, may be indicated in a control message from the transmitting device. The UEs 502, 504, 506, 508 may each be capable of operating as a transmitting device in addition to operating as a receiving device. Thus, UEs 506, 508 are illustrated as transmitting transmissions 516, 520. The transmissions 514, 516, 520 (and 518 by RSU 507) may be broadcast or multicast to nearby devices. For example, UE 514 may transmit communication intended for receipt by other UEs within a range 501 of UE 514. Additionally/alternatively, RSU 507 may receive communication from and/or transmit communication 518 to UEs 502, 504, 506, 508.

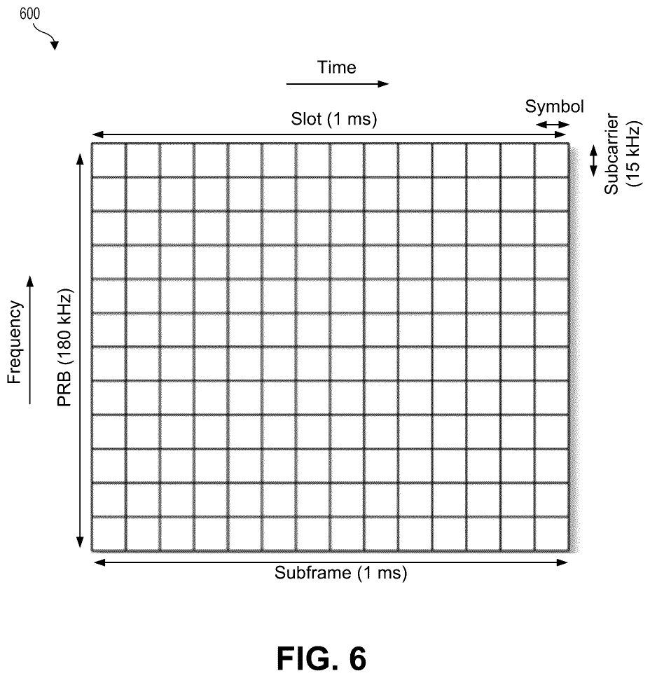

Data or information communicated using access link or sidelink-based signals may be included in one or more resource blocks. FIG. 6 is a diagram illustrating an example of a resource block (RB) 600 (also referred to as a physical resource block (PRB) 600). The RB 600 is arranged with the time domain on the horizontal (or x-) axis and the frequency domain on the vertical (or y-) axis. As shown, the RB 600 may be 180 kilohertz (kHz) wide in frequency and one slot long in time (with a slot being 1 milliseconds (ms) in time). In some cases, the slot may include fourteen symbols (e.g., in a slot configuration 0). The RB 600 includes twelve subcarriers (along the y-axis) and fourteen symbols (along the x-axis). An intersection of a symbol and subcarrier can be referred to as a resource element (RE) or tone. For instance, a RE is 1 subcarrier×1 symbol, and is the smallest discrete part of the subframe. A RE includes a single complex value representing data from a physical channel or signal.

Combination (comb) structures (also referred to as tone patterns) can be defined as specific arrangements of REs in a given resource block for transmission of a reference signal. Comb structures are currently pre-defined in the 3GPP communication standards (e.g., 5G/NR, 4G/LTE, etc.) and may be known to both the user equipment (UE) and corresponding network entity (e.g., base station or portion thereof).

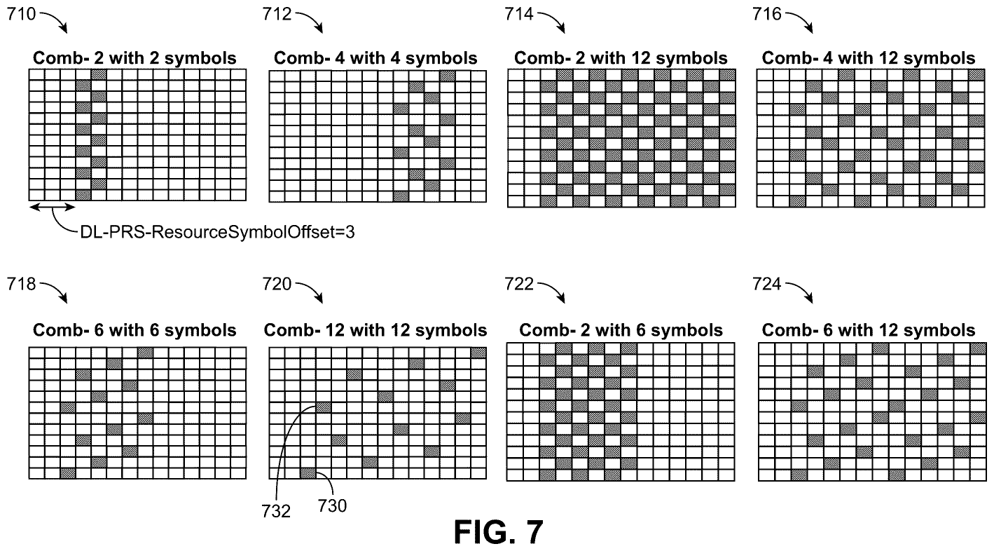

Examples of comb structures for reference signals (e.g., a PRS, SRS, etc.) are shown in FIG. 7. For example, the comb structure 710 is a comb-2 structure with two symbols (denoted as a comb-2/2-symbol structure). According to the comb-2/2-symbol structure of the comb structure 710, every alternate symbol is assigned to the reference signal resources. The comb patterns in FIG. 7 are for one Transmission-Reception Point (TRP). A summary of the comb structures 710, 712, 714, 716, 718, 720, 722, and 724 are provided in Table 1 below:

| | 2-Symbols | 4-Symbols | 6-Symbols | 12-Symbols |
|---|---|---|---|---|
| Comb-2 | {0, 1} | {0, 1, 0, 1} | {0, 1, 0, 1, 0, 1} | {0, 1, 0, 1, 0, 1, 0, 1, 0, 1, 0, 1} |
| Comb-4 | N/A | {0, 2, 1, 3} | N/A | {0, 2, 1, 3, 0, 2, 1, 3, 0, 2, 1, 3} |
| Comb-6 | N/A | N/A | {0, 3, 1, 4, 2, 5} | {0, 3, 1, 4, 2, 5, 0, 1, 3, 4, 2, 5} |
| Comb-12 | N/A | N/A | N/A | {0, 6, 3, 9, 1, 7, 4, 10, 2, 8, 5, 11} |

FIG. 8 is a diagram illustrating an example of a resource block (RB) 800 for sidelink positioning, according to some aspects of the present disclosure. In FIG. 8, the RB 800 is arranged with the time domain on the horizontal (or x-) axis and the frequency domain on the vertical (or y-) axis. The RB 800 may be one slot long in time (e.g., 1 ms in time). In one or more examples, the RB 800 may be employed for sidelink positioning and, as such, the RB 800 may be referred to as a “sidelink (SL) slot.”

In one or more cases, the SL slot (e.g., RB 800) may include fourteen symbols (e.g., in a slot configuration 0), which are located along with x-axis. Each of symbols may include various different types of data (e.g., an automatic gain control resource, a control channel resource, or a positioning resource, such as a PRS resource) or may be devoid of any data at all (e.g., a gap such as the gap 806). The RB 800 may also include twelve subcarriers, which may be referred to as a “resource pool,” that are located along the y-axis. The intersection of a symbol and a subcarrier of the RB 800 may be referred to as a resource element (e.g., a resource element is one subcarrier by one symbol in size). The first symbol 802 of the SL slot (e.g., RB 800) may include an automatic gain control (AGC) resource for AGC. Also, starting from the second symbol 804 of the SL slot (e.g., RB 800), a control channel resource may be implemented.

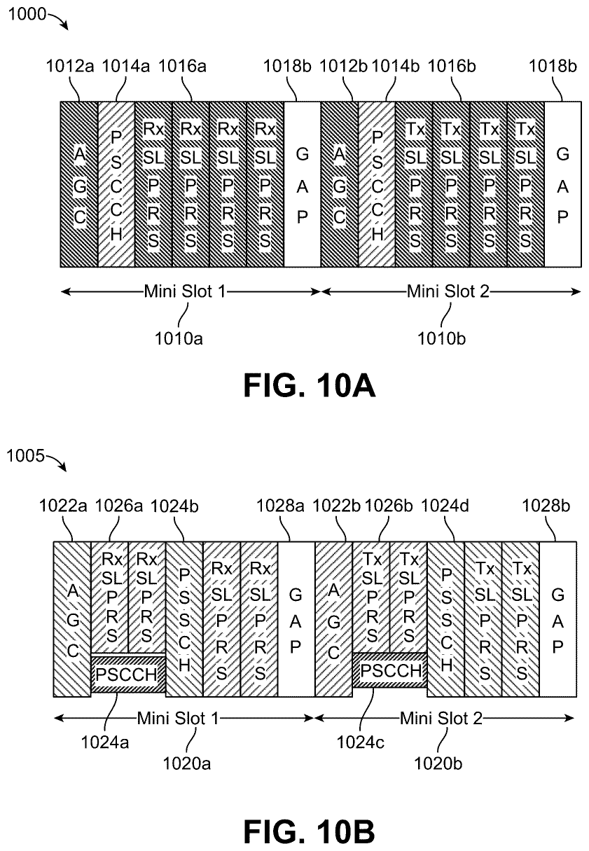

As described in more detail below, FIGS. 10A, 10B, 11A, 11B, 11C, 12A, 12B, 12C, 13D, 14A, and 14B are diagrams illustrating examples of slot structures that may be employed for the RB 800, which may be utilized by the disclosed system for providing mini slots (or slot portions) for sidelink positioning, as discussed in more detail below.

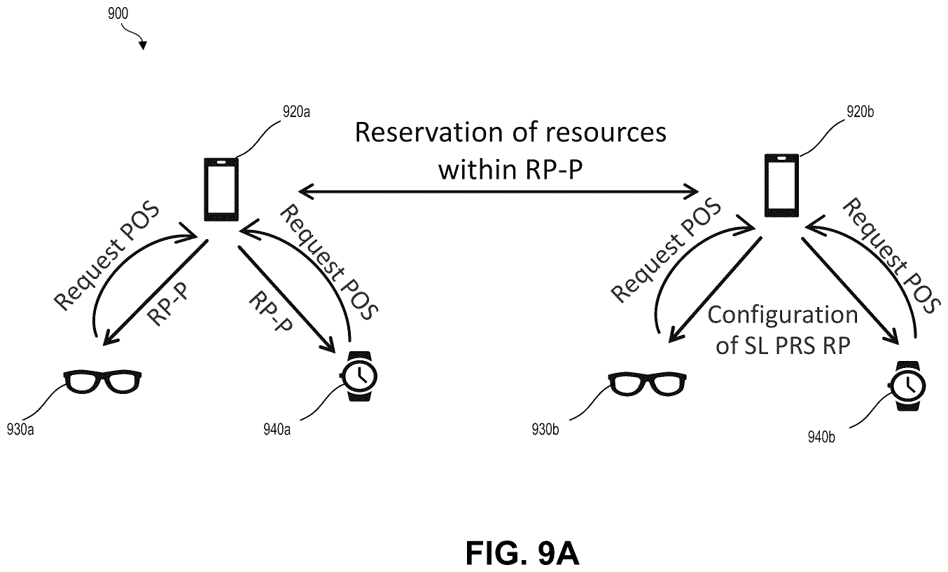

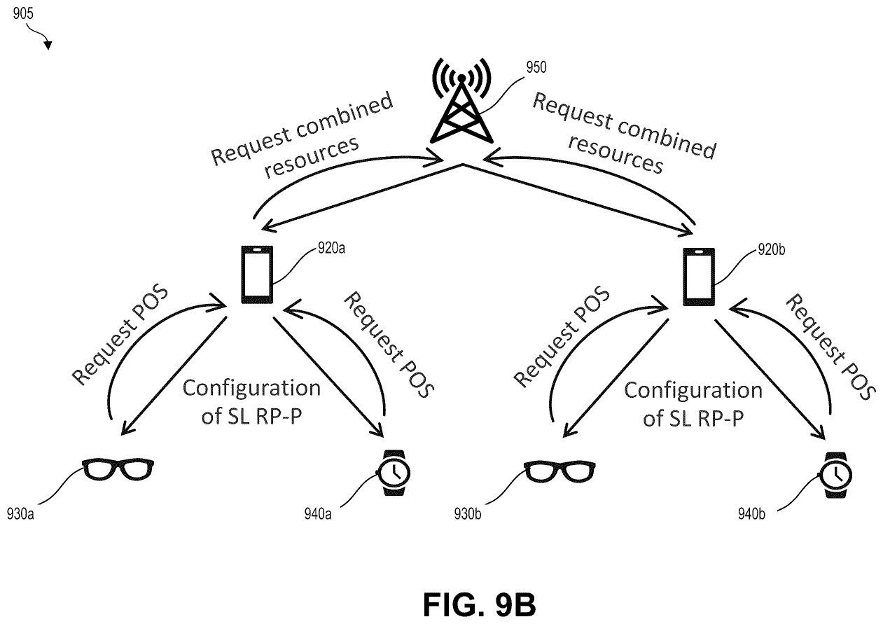

FIG. 9A is diagram illustrating an example of a system 900 including various devices exchanging sidelink communications based on resource pools, such as for sidelink positioning, according to some aspects of the present disclosure. In FIG. 9A, the system 900 is shown to include a plurality of network devices. The plurality of network devices includes UEs 920a, 920b, 930a, 930b, 940a, 940b, which may be in various different types of forms including, but not limited to, mobile devices or phones (e.g., UEs 920a, 920b), extended reality (XR) devices such as augmented reality (AR) or virtual reality (VR) headsets (e.g., UEs 930a, 930b), network-connected or smart watches (e.g., UEs 940a, 940b), and vehicles (e.g., vehicle 304 in FIG. 3). The system 900 may comprise more or less network devices, than as shown in FIG. 9A. In addition, the system 900 may comprise more or less different types of network devices (e.g., vehicles), than as shown in FIG. 9A. In addition, in one or more examples, the network devices (e.g., UEs 920a, 920b, 930a, 930b, 940a, and 940b) may be equipped with heterogeneous capability, which may include, but is not limited to, C-V2X/DSRC capability, 4G/5G cellular connectivity, GPS capability, camera capability, or other sensor-based capability (e.g., light or sound-based sensors such as a depth sensor using any suitable technology for determining depth).

The plurality of network devices (e.g., UEs 920a, 920b, 930a, 930b, 940a, and 940b) may be capable of performing communications (e.g., 5G NR communications). For example, as shown, the UE 920a and the UE 920b assign positioning resources from a resource pool (RP) for positioning (RP-P). In some cases, at least some of the network devices are capable of transmitting and receiving sensing signals using one or more sensors (e.g., RF sensing signals and/or optical sensing signals, such as using light or sound-based sensors) to detect nearby UEs and/or objects. In some cases, the network devices can detect nearby UEs and/or objects based on one or more images or frames captured using one or more cameras. In one or more examples, the network devices may be capable of transmitting and receiving sensing signals of some kind (e.g., camera, RF sensing signals, optical sensing signals, etc.).

In one or more examples, at least some the UEs 930a, 930b, 940a, 940b may determine to perform positioning (e.g., sidelink positioning). Sidelink positioning utilizes reference signals (e.g., PRSs) to obtain a position of a UE with respect to other objects, such as other UEs. In particular, sidelink positioning utilizes a round-trip time (RTT) measurement of a positioning reference signal (PRS). For example, when two UEs desire to position themselves with respect to one another, the of the UEs may each transmit a PRS and each of the UEs may measure the RTT of their respective transmitted signal. From the measured RTT, each of the UEs can determine their distance from one another and position themselves accordingly.

In some cases, during operation of the system 900, some of the network devices (e.g., UEs 930a, 940a, 930b, 940b) may determine to perform positioning (e.g., sidelink positioning) to determine their positions with respect to other UEs and position themselves accordingly. For example, UEs 930a and 940a may determine their distance from UE 920a and/or from each other to determine positions for themselves accordingly. In some cases, UEs 930b and 940b may determine their distance from UE 920b and/or from each other to position themselves accordingly. In such cases, the UEs 930a, 940a, 930b, 940b may transmit request signals or messages requesting a positioning session (e.g., Request Position (POS) signals) to UEs 920a, 920b.

After receiving the request signals requesting positioning (e.g., Request POS signals), the UEs 920a, 920b (e.g., which may operate as coordination UEs) may coordinate with each other to reserve positioning resources (e.g., PRS resources) for the requested positioning from a resource pool for positioning (RP-P). The resource pool for positioning may contain a plurality of positioning resources (e.g., PRS resources). In some examples the plurality of positioning resources may include transmit positioning resources (e.g., Tx PRS resources) and receive positioning resources (e.g., Rx PRS resources), which may have specific frequencies of operation and specific times of operation. The UEs 920a, 920b coordinate with each other regarding the reservation of positioning resources from the RP-P to minimize possible collisions caused by any possible duplicate reservation of positioning resources from the RP-P.

After the UEs 920a, 920b have coordinated with each other regarding the reservation of positioning resources and have determined which positioning resources from the RP-P to reserve for their requested positioning, the UEs 920a, 920b can each determine and generate a positioning resource configuration, which includes the reserved positioning resources to be utilized for the requested positioning. After the UEs 920a, 920b generate the positioning resource configurations to be used for the positioning, the UEs 920a, 920b may transmit a positioning resource configuration signal including the specific positioning resource configuration to the UEs 930a, 940a, 930b, 940b. For example, UE 920a may transmit a positioning resource configuration signal including the specific positioning resource configuration to the UEs 930a, 940a, and/or the UE 920b may transmit a positioning resource configuration signal including the specific positioning resource configuration to the UEs 930b, 940b.

After the UEs 930a, 940a, 930b, 940b receive the positioning resource configurations, the positioning (e.g., sidelink positioning) may be performed utilizing the specific positioning resources specified in the positioning resource configurations. In some aspects, the positioning resources in the positioning resource configurations may employ slot structures including mini slots (or slot portions), as discussed herein. Examples of slot structures employing mini slots that may be employed for the positioning resources are shown in FIGS. 10A, 10B, 11A, 11B, 11C, 12A, 12B, 12C, 13D, 14A, and 14B, described in further detail below.

FIG. 9B is diagram illustrating an example of a system 905 including various devices exchanging sidelink communications based on resource pools, such as for sidelink positioning, according to some aspects of the present disclosure. In FIG. 9B, the system 905 is shown to include a plurality of network devices and a network entity, which may be in the form of a base station (e.g., a gNB or eNB) or a portion of a base station (e.g., one or more of a central unit (CU), a distributed unit (DU), a radio unit (RU), a Near-Real Time (Near-RT) RAN Intelligent Controller (RIC), or a Non-Real Time (Non-RT) RIC of the base station). The plurality of network devices includes UEs 920a, 920b, 930a, 930b, 940a, 940b, which may be in various different types of forms including, but not limited to, mobile devices (e.g., UEs 920a, 920b), XR devices (e.g., UEs 930a, 930b), network-connected or smart watches (e.g., UEs 940a, 940b), and vehicles (e.g., vehicle 304 in FIG. 3). The system 905 may comprise more or less network devices and/or more or less network entities, than as shown in FIG. 9B. In addition, the system 905 may comprise more or less different types of network devices (e.g., vehicles) and/or network entities (e.g., network servers), than as shown in FIG. 9B. In addition, in one or more examples, the network devices (e.g., UEs 920a, 920b, 930a, 930b, 940a, and 940b) may be equipped with heterogeneous capability, which may include, but is not limited to, C-V2X/DSRC capability, 4G/5G cellular connectivity, GPS capability, camera capability, or other sensor-based capability (e.g., light or sound-based sensors such as a depth sensor using any suitable technology for determining depth).

The plurality of network devices (e.g., UEs 920a, 920b, 930a, 930b, 940a, and 940b) and network entity 950 (e.g., base station) may be capable of performing communications (e.g., 5G NR communications). For example, as shown, a network entity 950 (e.g., base station) assigns positioning resources from a resource pool for positioning (RP-P). At least some of the network devices may be capable of transmitting and receiving sensing signals using one or more sensors (e.g., RF sensing signals and/or optical sensing signals, such as using light or sound-based sensors) to detect nearby UEs and/or objects. In some cases, the network devices can detect nearby UEs and/or objects based on one or more images or frames captured using one or more cameras. In one or more examples, the network devices may be capable of transmitting and receiving sensing signals of some kind (e.g., camera, RF sensing signals, optical sensing signals, etc.).

In some cases, during operation of the system 905, some of the network devices (e.g., UEs 930a, 940a, 930b, 940b) may determine to perform positioning (e.g., sidelink positioning) to determine their positions with respect to other UEs and position themselves accordingly. In one or more examples, UEs 930a and 940a may determine their distance from UE 920a and/or from each other to position themselves accordingly. In some examples, UEs 930b and 940b may determine their distance from UE 920b and/or from each other to position themselves accordingly. In such examples, the UEs 930a, 940a, 930b, 940b may transmit request signals requesting positioning (e.g., Request POS signals) to the UEs 920a, 920b.

After receiving the request signals requesting positioning (e.g., Request POS signals), the UEs 920a, 920b (e.g., which may operate as relay UEs) may send request signals requesting combined resources for positioning to the network entity 950. The request signals requesting combined resources for positioning include requests for an assignment of combined positioning resources for positioning performed by the UEs 930a, 940a, 930b, 940b.

After receiving the request signals requesting combined resources for positioning from the UEs 920a, 920b, the network entity 950 may determine and assign a set of combined positioning resources (e.g., PRS resources, including Tx PRS resources and RX PRS resources) from the resource pool for positioning (RP-P) to each of the UEs 920a, 920b (e.g., which may be operating as relay UEs), where the positioning resources within a set of combined positioning resources are to be parsed out and assigned by the UEs (e.g., 920a, 920b) operating as relays to the UEs (e.g., UEs 930a, 940a, 930b, 940b) desiring the positioning. After the network entity 950 has determined and assigned the sets of combined positioning resources, the network entity 950 may transmit signals comprising the assignment of the sets of combined positioning resources to the UEs 920a, 920b.

After the UEs 920a, 920b have received the signals comprising the assignment of the sets of the combined positioning resources, the UEs 920a, 920b can each determine and generate a positioning resource configuration for the UEs 930a, 940a, 930b, 940b utilizing positioning resources within the received sets of the combined positioning resources. For example, the UE 920a may determine and generate a positioning resource configuration for each of the UEs 930a, 940a utilizing positioning resources within the received set of the combined positioning resources from the network entity 950. For another example, the UE 920b may determine and generate a positioning resource configuration for each of UEs 930b, 940b utilizing positioning resources within the received set of the combined positioning resources from the network entity 950.

After the UEs 920a, 920b generate the positioning resource configurations to be used for the positioning, the UEs 920a, 920b may transmit a positioning resource configuration signal including the specific positioning resource configuration to the UEs 930a, 940a, 930b, 940b. For example, UE 920a may transmit a positioning resource configuration signal including the specific positioning resource configuration to the UEs 930a, 940a. For another example, the UE 920b may transmit a positioning resource configuration signal including the specific positioning resource configuration to the UEs 930b, 940b.

After the UEs 930a, 940a, 930b, 940b receive the positioning resource configurations, the positioning (e.g., sidelink positioning) may be performed utilizing the specific positioning resources specified in the positioning resource configurations. The positioning resources in the positioning resource configurations may employ slot structures including mini slots. Examples of slot structures employing mini slots that may be employed for the positioning resources are illustrated in FIGS. 10A, 10B, 11A, 11B, 11C, 12A, 12B, 12C, 13D, 14A, and 14B, described in more detail below.

As previously described, a resource block (e.g., made up of fourteen or twelve OFDM symbols in a slot, as shown in FIG. 8) may include a plurality of mini slots (also referred to herein as slot portions) having reference signal (e.g., PRS) resources. FIG. 10A is a diagram illustrating an example of a slot structure 1000 including a mini slot 1010a and a mini slot 1010b, according to some aspects of the present disclosure. The mini slots 1010a, 1010b include control channels 1014a, 1014b that are separate from positioning resources 1016a, 1016b in the frequency domain (e.g., the control channels 1014a, 1014b are not frequency division multiplexed with the positioning resources 1016a, 1016b). FIG. 10B is a diagram illustrating another example of a slot structure 1005 including a mini slot 1020a and a mini slot 1020b. The mini slots 1020a, 1020b of FIG. 10B include control channels 1024a, 1024c that are frequency division multiplexed with positioning resources 1026a, 1026b, according to some aspects of the present disclosure. By frequency division multiplexing the control channels 1024a, 1024c with the positioning resources 1026a, 1026b, an additional symbol is available for a shared channel resource (e.g., the PSSCH 1024b and the PSSCH 1024d of FIG. 10B).

In FIGS. 10A and 10B, the slot structures 1000, 1005 are each arranged with the time domain on the horizontal (or x-) axis and the frequency domain on the vertical (or y-) axis. The slot structures 1000, 1005 may each be one slot long in the time domain (e.g., 1 ms in time). In one or more examples, the slot structures 1000, 1005 may be employed for positioning (e.g., sidelink positioning). In FIGS. 10A and 10B, the slot structures 1000, 1005 are each shown to include two mini slots, which include a first mini slot (e.g., mini slot 1) 1010a, 1020a and a second mini slot (e.g., mini slot 2) 1010b, 1020b. In one or more examples, the slot structures 1000, 1005 of FIGS. 10A and 10B may include more mini slots than as shown in FIGS. 10A and 10B.

As illustrated in FIG. 10A, each of the mini slots 1010a, 1010b of the slot structure 1000 include an automatic gain control (AGC) resource 1012a, 1012b, a control channel resource 1014a, 1014b (e.g., a physical sidelink control channel (PSCCH)), a plurality of positioning resources 1016a, 1016b (e.g., PRS resources, which can include Tx PRS resources and Rx PRS resources for sidelink positioning), and a gap 1018a, 1018b. The gap 1018a and the gap 1018b are devoid of any data (e.g., the gaps 1018a, 1018b may not include any data and thus may include empty symbols). As shown, the mini slots 1010a, 1010b of the slot structure 1000 of FIG. 10A have control channel resources 1014a, 1014b that are separate from the positioning resources 1016a, 1016b.

As illustrated in FIG. 10A, while only one positioning resource 1016a, 1016b is labeled with a reference numeral for simplicity purposes for each of the mini slots 1010a, 1010b, the mini slots 1010a, 1010b of the slot structure 1000 each include four positioning resources in four of the symbols (one resource in each symbol) of the corresponding mini slot 1010a, 1010b. In particular, mini slot 1010a includes four positioning resources (including positioning resource 1016a), which are Rx PRS resources, and mini slot 1010b includes four positioning resources (including positioning resource 1016b), which are Tx PRS resources. In one or more examples, the mini slots 1010a, 1010b of the slot structure 1000 of FIG. 10A may include more or less positioning resources and/or include more or less different types of resources for the symbols, than as is shown in FIG. 10A.

In FIG. 10B, each of the mini slots 1020a, 1020b of the slot structure 1005 includes an AGC resource 1022a, 1022b, a control channel resource 1024a, 1024c (e.g., PSCCH) that includes control information (e.g., with respect to scheduled resources), a shared channel resource 1024b, 1024d (e.g., PSSCH) that includes communications data, a plurality of positioning resources 1026a, 1026b (e.g., Tx PRS resources and Rx PRS resources for sidelink positioning), and a gap 1028a, 1028b. Although only one positioning resource 1026a, 1026b is labeled with a reference numeral in FIG. 10B for simplicity purposes for each of the mini slots 1020a, 1020b, the mini slots 1020a, 1020b of the slot structure 1005 each include four positioning resources in four of the symbols (one resource in each symbol) of the corresponding mini slot 1020a, 1020b. Specifically, mini slot 1020a includes four positioning resources (including positioning resource 1026a), which are Rx PRS resources, and mini slot 1020b includes four positioning resources (including positioning resource 1026b), which are Tx PRS resources. In one or more examples, the mini slots 1020a, 1020b of the slot structure 1005 of FIG. 10B may include more or less positioning resources and/or include more or less different types of resources for the symbols, than as is shown in FIG. 10B.

In FIG. 10B, each of the mini slots 1020a, 1020b of the slot structure 1005 have control channel resources 1024a, 1024c that are frequency division multiplexed with two of the four positioning resources 1026a, 1026b. In particular, mini slot 1020a of the slot structure 1005 has a control channel resource 1024a (e.g., PSCCH) that is frequency division multiplexed with two positioning resources 1026a (e.g., Rx PRS resources). Mini slot 1020b of the slot structure 1005 has a control channel resource 1024c (e.g., PSCCH) that is frequency division multiplexed with two positioning resources 1026b (e.g., Tx PRS resources). In FIG. 10A, the control channel resource 1014a, 1014b (e.g., the PSCCH resources) are time division multiplexed with the other resources and channels, which may be low in complexity. In some cases, if the operating bandwidth is large, there may not be a need to use the entire bandwidth for the PSCCH. In such cases, the slot structure 1005 of FIG. 10B may be used, where a UE can reuse part of the bandwidth on the PSCCH symbol for receiving sidelink PRS symbols.

In some aspects, such as to support the the slot structures 1000, 1005 of FIG. 10A and FIG. 10B, a UE may be configured with UE capability to support mini-slot scheduling of sidelink reference signals (e.g., sidelink reference signals including positioning resources, such as sidelink PRSs). In one illustrative example, a UE may be provided with the capability to monitor a control channel (e.g., PSCCH) for control channel resources (e.g., PSCCH resources) on a mini-slot basis in a sidelink slot (e.g., the control channel resource 1014a in the mini slot 1010a, the control channel resource 1014b in the mini slot 1010b, the control channel resource 1024a in the mini slot 1020b, the control channel resource 1024c in the mini slot 1020b, etc.). The control channel resource (e.g., PSCCH resource) can schedule receive sidelink positioning resources (e.g., SL-PRS receive resources) and/or transmit sidelink positioning resources (e.g., SL-PRS transmit resources), such as the receive positioning resources 1016a in the mini slot 1010a of FIG. 10A, the transmit positioning resources 1016b in the mini slot 1010b of FIG. 10A, or other reference signal resource. The UE capability may be on a per-band basis, a per-frequency basis, or the like. In some cases, the UE capability may allow the UE to support reference signal resources (e.g., positioning resources, such as PRS resources) frequency division multiplexed with a control channel such as a PSCCH (e.g., the control channel resource 1024a or the control channel 1024c multiplexed with the corresponding positioning resource 1026a, 1026b, respectively).

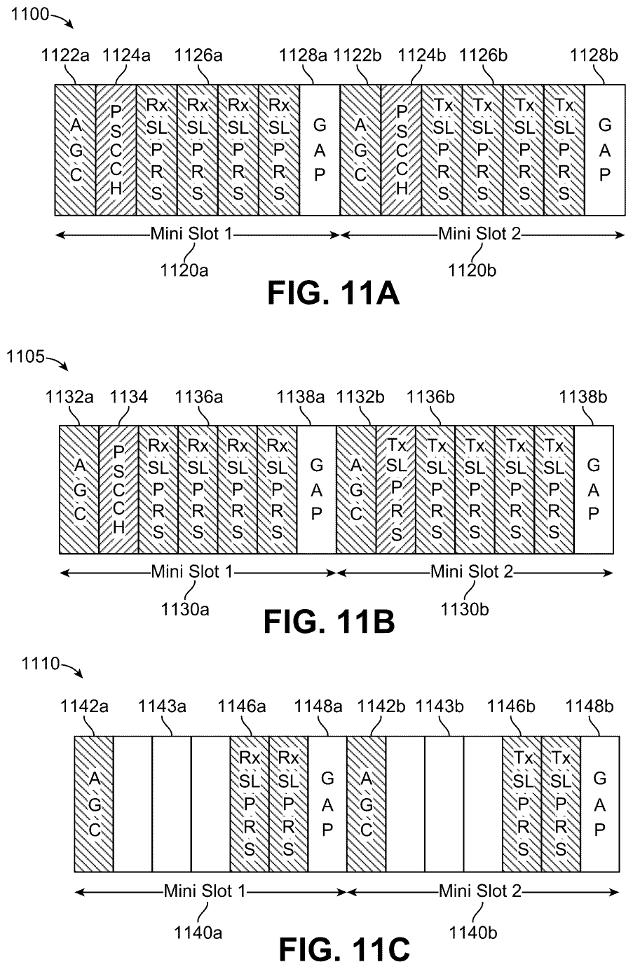

FIG. 11A is a diagram illustrating an example of a slot structure 1100 including mini slots 1120a, 1120b having a control channel resource 1124a, 1124b within each mini slot 1120a, 1120b, according to some aspects of the present disclosure. FIG. 11B is a diagram illustrating an example of a slot structure 1105 including mini slots 1130a, 1130b sharing a single control channel resource 1134 across the mini slots 1130a, 1130b, according to some aspects of the present disclosure. FIG. 11C is a diagram illustrating an example of a slot structure 1110 including mini slots 1140a, 1140b without any control channel resource, according to some aspects of the present disclosure.

In FIGS. 11A, 11B, and 11C, the slot structures 1100, 1105, 1110 are each arranged with the time domain on the horizontal (or x-) axis and the frequency domain on the vertical (or y-) axis. The slot structures 1100, 1105, 1120 may each be one slot long in time (e.g., 1 ms in time). The slot structures 1100, 1105, 1110, in one or more examples, may be employed for positioning (e.g., sidelink positioning). In FIGS. 11A, 11B, and 11C, the slot structures 1100, 1105, 1110 are each shown to include two mini slots, which include a first mini slot (e.g., mini slot 1) 1120a, 1130a, 1140a and a second mini slot (e.g., mini slot 2) 1120b, 1130b, 1130c. In one or more examples, the slot structures 1100, 1105, 1110 of FIGS. 11A, 11B, and 11C may include more mini slots than as is shown in FIGS. 11A, 11B, and 11C.

In particular, in FIG. 11A, each of the mini slots 1120a, 1120b of the slot structure 1100 is shown to include an AGC resource 1122a, 1122b, a control channel resource (e.g., a PSCCH) 1124a, 1124b, a plurality of positioning resources (e.g., PRS resources, such as Tx PRS resources and Rx PRS resources for sidelink positioning) 1126a, 1126b, and a gap 1128a, 1128b, which does not contain any data. As shown in FIG. 11A, each of the mini slots 1120a, 1120b has its own dedicated control channel (e.g., a PSCCH) resource 1124a, 1124b. Although only one positioning resource 1126a, 1126b is labeled with a reference numeral in FIG. 11A for simplicity purposes for each of the mini slots 1120a, 1120b, the mini slots 1120a, 1120b of the slot structure 1100 each include four positioning resources in four of the symbols (one resource in each symbol) of the corresponding mini slot 1120a, 1120b. In particular, mini slot 1120a includes four positioning resources (including positioning resource 1126a), which are Rx PRS resources, and mini slot 1120b includes four positioning resources (including positioning resource 1126b), which are Tx PRS resources. In one or more examples, the mini slots 1120a, 1120b of the slot structure 1100 of FIG. 11A may include more or less positioning resources and/or include more or less different types of resources for the symbols, than as is shown in FIG. 11A. The slot structure 1100 of FIG. 11A allows for two opportunities to dynamically schedule resources (e.g., sidelink PRS resources) in either one of the mini slots 1120a, 1120b.

In FIG. 11B, each of the mini slots 1130a, 1130b of the slot structure 1105 is shown to include an AGC resource 1132a, 1132b, a plurality of positioning resources (e.g., PRS resources, such as Tx PRS resources and Rx PRS resources for sidelink positioning) 1136a, 1136b, and a gap 1138a, 1138b. Although only one positioning resource 1136a, 1136b is labeled with a reference numeral in FIG. 11B for simplicity purposes for each of the mini slots 1130a, 1130b of the slot structure 1105, the mini slots 1130a, 1130b of the slot structure 1105 each include four positioning resources in four of the symbols (one resource in each symbol) of the corresponding mini slot 1130a, 1130b. Specifically, mini slot 1130a includes four positioning resources (including positioning resource 1136a), which are Rx PRS resources, and mini slot 1130b includes four positioning resources (including positioning resource 1136b), which are Tx PRS resources.

For the slot structure 1105 of FIG. 11B, there is a common control channel (e.g., a PSCCH) resource 1134 for both of the mini slots 1130a, 1130b that is included within the first mini slot 1130a. Although the control channel resource 1134 is only included within the first mini slot 1130a, the control channel resource 1134 is scheduled across and includes control information (e.g., scheduling information) that is applicable to both of the mini slots 1130a, 1130b of the slot structure 1105, which can be referred to as “inter-mini slot PRS scheduling.” In one or more examples, a high level configuration for the slot structure 1105 can indicate where the first mini slot 1130a of the slot structure 1105 begins and ends, and where the second mini slot 1130b of the slot structure 1105 begins and ends. The control channel resource 1134 is scheduled across both of the mini slots 1130a, 1130b of the slot structure and, as such, can provide control for both of the mini slots 1130a, 1130b. In one or more examples, the mini slots 1130a, 1130b of the slot structure 1105 of FIG. 11B may include more or less positioning resources and/or include more or less different types of resources for the symbols, than as is shown in FIG. 11B. The slot structure 1105 of FIG. 11B has one less symbol for control channel resources (e.g., PSCCH resources) and thus less overhead as compared to the slot structure 1100 in FIG. 11A.

In FIG. 11C, each of the mini slots 1140a, 1140b of the slot structure 1110 is shown to include an AGC resource 1142a, 1142b, a positioning resource 1146a, 1126b (e.g., a PRS resource, such as a Tx PRS resource or an Rx PRS resource for sidelink positioning), and a gap 1128a, 1128b, which does not contain any data. In particular, the first mini slot 1140a includes an Rx PRS resource for its positioning resource 1146a, and the second mini slot 1140b includes a Tx PRS resource for its positioning resource 1146b. Each of the mini slots 1140a, 1140b of the slot structure 1110 is also shown to include several blank symbols 1143a, 1143b (e.g., three blank symbols). In one or more examples, each of these blank symbols 1143a, 1343b in the mini slots 1140a, 1140b may include various different types of resources. In one or more examples, the mini slots 1140a, 1140b of the slot structure 1110 of FIG. 11C may include more or less positioning resources and/or include more or less different types of resources for the symbols, than as is shown in FIG. 11C. In FIG. 11C, neither of the mini slots 1140a, 1140b of the slot structure 1110 includes a control channel resource (e.g., a PSCCH). It should be noted that, in one or more examples, when there is a scheduling of the positioning resources by a network entity (e.g., network entity 1150 of FIG. 11B), such as a mode 1 operation (where sidelink resources are scheduled by a base station or portion thereof, such as a gNB or one or more of a CU, a DU, a RU, a Near-RT RIC, or a Non-RT RIC of the gNB), the slot structure (e.g., slot structure 1110) does not need to include a control channel resource (e.g., a PSCCH resource). The slot structure 1110 of FIG. 11C does not include any control channel resources (e.g. PSCCH resources) in either of the mini slot 1140a, 1140b, for example because the sidelink PRS resources may be scheduled semi-statically, which can avoid the control overhead.

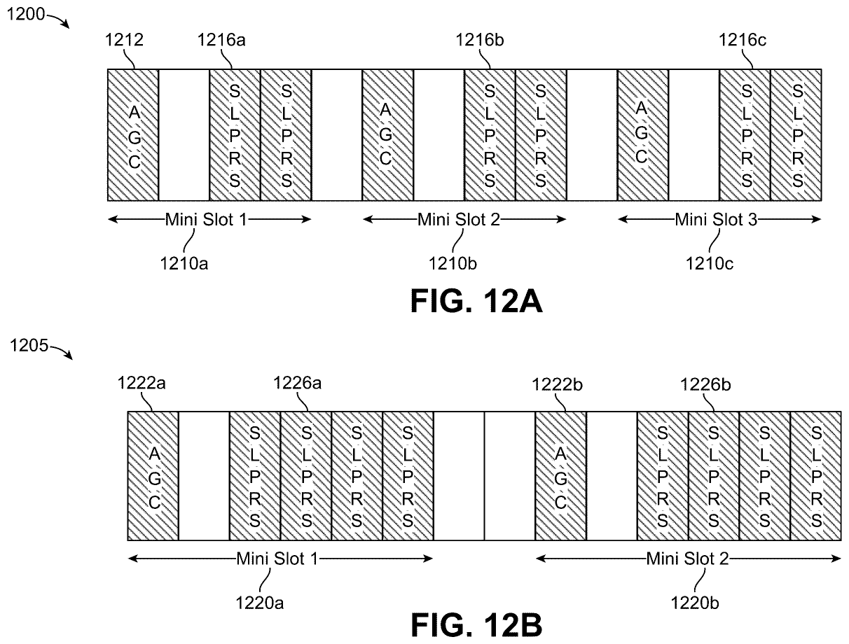

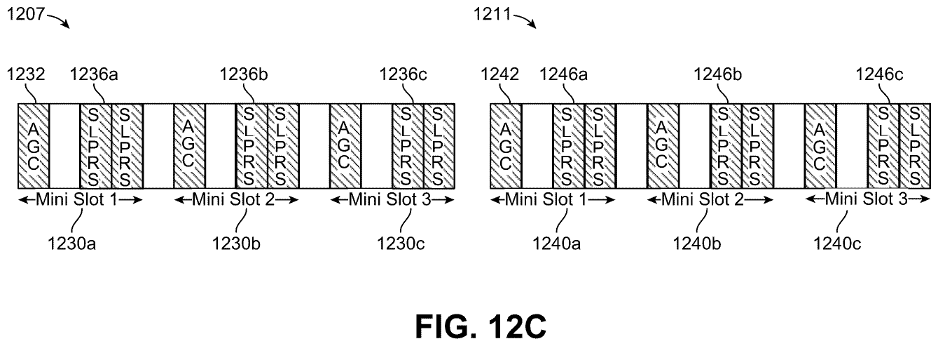

FIG. 12A is a diagram illustrating an example of a slot structure 1200 including three mini slots 1210a, 1210b, 1210c, according to some aspects of the present disclosure. FIG. 12B is a diagram illustrating an example of a slot structure 1205 including two mini slots 1220a, 1220b, according to some aspects of the present disclosure. In FIGS. 12A and 12B, the slot structures 1200, 1205 are each arranged with the time domain on the horizontal (or x-) axis and the frequency domain on the vertical (or y-) axis. The slot structures 1200, 1205 may each be one slot long in time (e.g., 1 ms in time). In one or more examples, the slot structures 1200, 1205, may be employed for positioning (e.g., sidelink positioning). In one or more examples, the slot structures 1200, 1205 of FIGS. 12A and 12B may each include more or less mini slots than as is shown in FIGS. 12A and 12B.

In FIG. 12A, the slot structure 1200 shown to include three mini slots, which include a first mini slot (e.g., mini slot 1) 1210a, a second mini slot (e.g., mini slot 2) 1210b, and a third mini slot (e.g., mini slot 3) 1210c. The additional mini slots in the slot structure 1200 allow for more scheduling flexibility compared to fewer mini slots in a particular slot. Each of the mini slots 1210a, 1210b, 1210c of the slot structure 1200 is shown to include two positioning resources (e.g., PRS resources, such as a SL PRS, which may be a Tx PRS resource or an Rx PRS resource for sidelink positioning) 1216a, 1216b, 1216c. Although only one positioning resource 1216a, 1216b, 1216c is labeled with a reference numeral in FIG. 12A for simplicity purposes for each of the mini slots 1210a, 1210b, 1210c of the slot structure 1200, the mini slots 1210a, 1210b, 1210c of the slot structure 1200 each include two positioning resources in two of the symbols (one resource in each symbol) of the corresponding mini slot 1210a, 1210b, and 1210c.

Each of the mini slots 1210a, 1210b, 1210c of the slot structure 1200 is also shown to include a blank symbol. In one or more examples, each of these blank symbols in the mini slots 1210a, 1210b, 1210c may include various different types of resources. For the slot structure 1200 of FIG. 12A, there is only one AGC resource 1212, which is included within the first mini slot 1210a. In one or more examples, the mini slots 1210a, 1210b, 1210c of the slot structure 1200 of FIG. 12A may include more or less positioning resources and/or include more or less different types of resources for the symbols, than as is shown in FIG. 12A.

In FIG. 12B, the slot structure 1205 shown to include two mini slots, which include a first mini slot (e.g., mini slot 1) 1220a and a second mini slot (e.g., mini slot 2) 1220b. Each of the mini slots 1220a, 1220b of the slot structure 1205 is shown to include an AGC resource 1222a, 1222b and four positioning resources (e.g., PRS resources, such as a SL PRS, which may be a Tx PRS resource or an Rx PRS resource for sidelink positioning) 1226a, 1226b. Although only one positioning resource 1226a, 1226b is labeled with a reference numeral in FIG. 12B for simplicity purposes for each of the mini slots 1220a, 1220b of the slot structure 1205, the mini slots 1220a, 1220b of the slot structure 1205 each include four positioning resources in four of the symbols (one resource in each symbol) of the corresponding mini slot 1220a and 1220b.

Each of the mini slots 1220a, 1220b of the slot structure 1205 is also shown to include a blank symbol. In one or more examples, these blank symbols in the mini slots 1220a, 1220b may include various different types of resources. In one or more examples, the mini slots 1220a, 1220b of the slot structure 1205 of FIG. 12B may include more or less positioning resources and/or include more or less different types of resources for the symbols, than as is shown in FIG. 12B.

FIG. 12C is a diagram that illustrates another example of a slot structure of two slots having slot structures 1207 and 1211, respectively, where a positioning resource configuration is repeated across the slots within mini slots 1230a, 1230b, 1230c, 1240a, 1240b, 1240c of the slot structures 1207, 1211. As shown, the slot structures 1207, 1211 are configured such that the PRS resource configuration is repeated within the mini slots 1230a, 1230b, 1230c, 1240a, 1240b, 1240c of the slot structures 1207, 1211. As such, the slot structures 1207, 1211 of FIG. 12C are identical to each other with regard to the positioning resources, such as PRS resources, although the actual resources may be different in the different slots.

In FIG. 12C, the slot structures 1207, 1211 are each arranged with the time domain on the horizontal (or x-) axis and the frequency domain on the vertical (or y-) axis. The slot structures 1207, 1211 may each be one slot long in time (e.g., 1 ms in time). In one or more examples, the slot structures 1207, 1211, may be employed for positioning (e.g., sidelink positioning). In one or more examples, the slot structures 1207, 1211 of FIG. 12C may each include more or less mini slots than as is shown in FIG. 12C.

In FIG. 12C, the slot structures 1207, 1211 are each shown to include three mini slots, which include a first mini slot (e.g., mini slot 1) 1230a, 1240a, a second mini slot (e.g., mini slot 2) 1230b, 1240b, and a third mini slot (e.g., mini slot 3) 1230c, 1240c. Each of the mini slots 1230a, 1230b, 1230c, 1240a, 1240b, 1240c of the slot structures 1207, 1211 is shown to include two positioning resources (e.g., PRS resources, such as a SL PRS, which may be a Tx PRS resource or an Rx PRS resource for sidelink positioning) 1236a, 1236b, 1236c, 1246a, 1246b, 1246c. In each of the slot structures 1207, 1211, there is only one AGC resource 1232, 1242, which is included within the first mini slot 1230a, 1240a of the slot structures 1207, 1211.

Each of the mini slots 1230a, 1230b, 1230c, 1240a, 1240b, 1240c of the slot structures 1207, 1211 are also shown to include a blank symbol. In one or more examples, these blank symbols in the mini slots 1230a, 1230b, 1230c, 1240a, 1240b, 1240c may include various different types of resources (e.g., control channel resources, such as a PSCCH). In one or more examples, the mini slots 1230a, 1230b, 1230c, 1240a, 1240b, 1240c of the slot structures 1207, 1211 of FIG. 12C may include more or less positioning resources and/or include more or less different types of resources for the symbols, than as is shown in FIG. 12C. However, the slot structures 1207, 1211 may be configured such that the PRS resource configuration (e.g., configuration of PRS resources 1236a, 1236b, 1236c, 1246a, 1246b, 1246c) is repeated within the mini slots 1230a, 1230b, 1230c, 1240a, 1240b, 1240c.

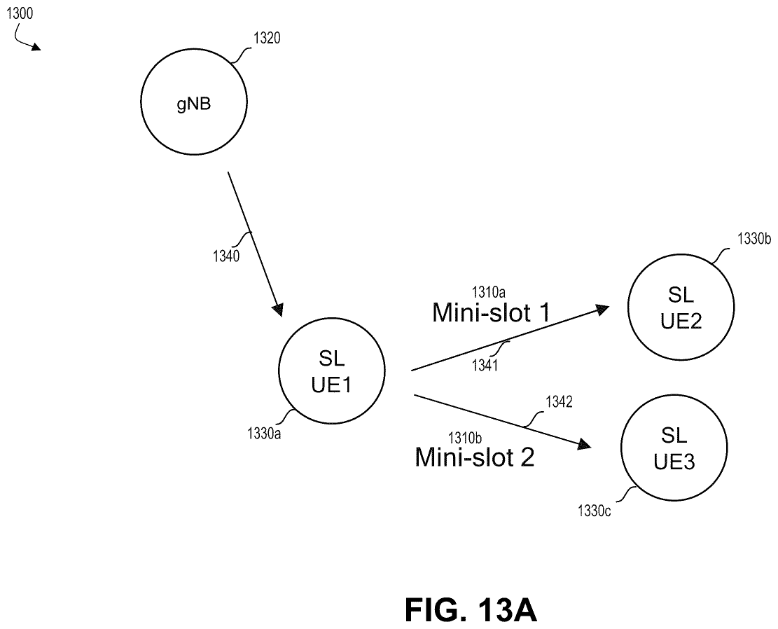

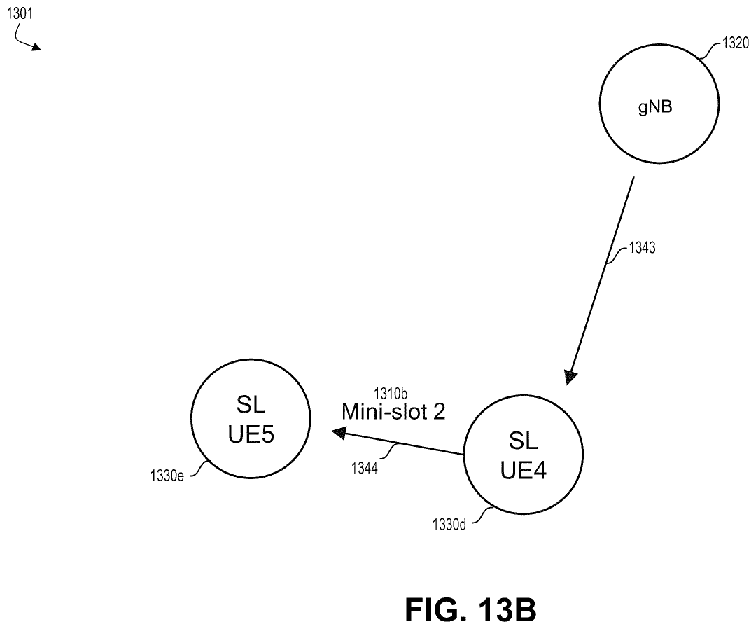

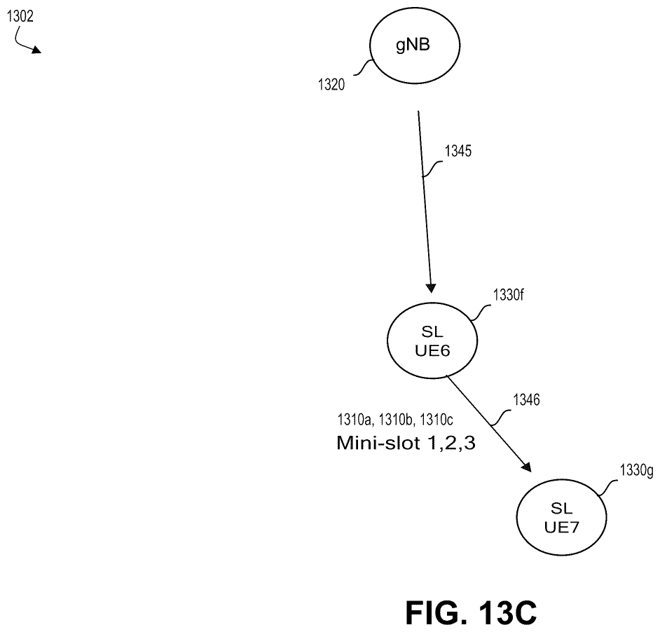

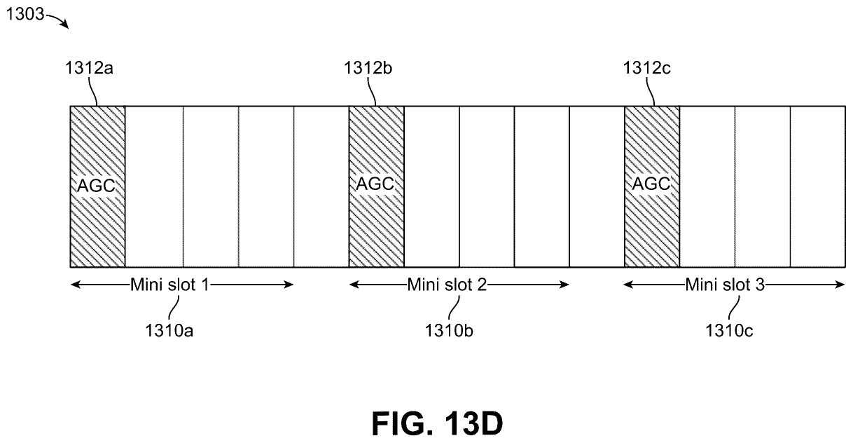

FIGS. 13A, 13B, and 13C show examples of systems 1300, 1301, 1303 that use mini slots (e.g., mini slots 1310a, 1310b, 1310c of FIG. 13D) for sidelink communications (e.g., for sidelink positioning). It should be noted that the systems 1300, 1301, 1303 may be operated utilizing at least one of two modes of operation for positioning (e.g., sidelink positioning), which are a mode 1 operation and a mode 2 operation. For example, the system 1300 of FIG. 13A utilizes a hybrid of both modes (e.g., both mode 1 and mode 2) of operation.

FIG. 13A is diagram illustrating an example of a system 1300 for providing mini slots for sidelink positioning, where a transmit (Tx) UE 1330a assigns specific mini slots (e.g., mini slot 1 1310a and mini slot 2 1310b of slot 1303 of FIG. 13D) for transmission to receive (Rx) UEs 1330b, 1330c, according to some aspects of the present disclosure. In FIG. 13A, the system 1300 is shown to include a first network entity (e.g., a base station, such as a gNB or eNB, or a network server) 1320, a Tx UE (e.g., a mobile device, XR device, network-connected watch, or vehicle) 1330a, and two Rx UEs (e.g., a mobile device, XR device, network-connected watch, or vehicle) 1330b, 1330c. In addition, in one or more examples, the Tx UE 1330a and the Rx UEs 1330a, 1330c may be equipped with heterogeneous capability, which may include, but is not limited to, C-V2X/DSRC capability, 4G/5G cellular connectivity, GPS capability, camera capability, or other sensor-based capability (e.g., light or sound-based sensors such as a depth sensor using any suitable technology for determining depth).

Details of the two modes of operation for positioning, with reference to the devices of the system 1300 of FIG. 13A, is described as follows. For mode 1 operation, a first network entity (e.g., a base station, such as a gNB or eNB, or a network server), such as network entity 1320, may indicate to a transmit (Tx) UE (e.g., a mobile device, XR device, network-connected watch, or vehicle), such as Tx UE 1330a, specific positioning resources (e.g., PRS resources, such as Tx PRS resources) to use for the Tx UE's sidelink transmissions (e.g., the first network entity may indicate a transmit grant).

In one or more examples, the first network entity (e.g., network entity 1320) may utilize downlink control information (DCI), such as DCI3_0, to indicate to the Tx UE (e.g., Tx UE 1330a of FIG. 13A) which specific positioning resources to use for sidelink transmissions. It should be noted that the DCI3_0 standard contains a “time resource assignment” information field. The first network entity (e.g., gNB) may use the “time resource assignment” information field in DCI3_0 to indicate to the Tx UE which specific slots to use for the sidelink transmissions. In one or more examples, the first network entity (e.g., gNB) may indicate to the Tx UE up to three slots for the sidelink transmissions, where the first slot may be utilized for the initial transmission, and the second and third slots may be utilized for retransmissions.

In some aspects, Rx UEs (e.g., Rx UE 1330b) can monitor each mini slot for sidelink control information (SCI) indicating which mini-slot(s) to monitor. In some cases (e.g., in the examples of FIG. 13A and FIG. 13B), a Tx UE (e.g., Tx UE 1330a) can configure an Rx UE or provide the Rx UE with information (e.g., control information via a control channel such as PSCCH) indicating which mini slot(s) to monitor. In some examples (e.g., in the example of FIG. 13C), a base station (e.g., gNB 1320) can configure an Rx UE or provide the Rx UE with information (e.g., control information via a control channel such as PDCCH) indicating which mini slots to monitor. In one illustrative example, the Tx UE (e.g., Tx UE 1330a) may utilize sidelink control information (SCI) to indicate to an Rx UE (e.g., Rx UE 1330b) which specific slots contain the sidelink transmissions. Similar to DCI3_0, SCI also contains a “time resource assignment” information field. In one or more examples, the Tx UE may transmit the SCI to the Tx UE, where the “time resource assignment” information field of the SCI is used to indicate to the Rx UE which slots contain the sidelink transmissions.

In one or more examples, for mode 1 operation for positioning, a second network entity, which may be a location server such as a location management function (LMF), may calculate, determine, and assign specific positioning resources to be used by a Tx UE (e.g., Tx UE 1330a) and/or an Rx UE (e.g., Rx UE 1330b or Rx UE 1330c) for the sidelink transmissions (e.g., Tx PRS resources) and/or sidelink receiving (e.g., Rx PRS resources). The second network entity (e.g., LMF) may also generate assistance data (AD), which can be used for the configuration of the positioning resources for sidelink positioning. In one or more examples, the second network entity (e.g., LMF) may be co-located or located remotely from the first network entity (e.g., network entity 1320).

In some examples, for mode 1 operation, the Tx UE (e.g., Tx UE 1330a) may provide information (e.g., capability information) to the second network entity (e.g., LMF) regarding all of the slot configurations (including mini slots) that the Tx UE is supporting for its sidelink positioning. In other examples, for mode 1 operation, a Tx UE (e.g., Tx UE 1330a) may provide the status of its current mini slot operation mode. For example, at the beginning of each sidelink positioning session (e.g., between two or more UEs, including at least one Tx UE and at least one Rx UE), as part of an initial set up or as part of requesting AD, the Tx UE may provide the current mini-slot configuration to the second network entity (e.g., LMF). The current mini-slot configuration may include, but is not limited to, information regarding the symbols of the mini slots that are utilized for a control channel (e.g., PSCCH), the symbols of the mini slots that are utilized for sidelink positioning, and/or the number of gap symbols utilized for the mini slots.

In one or more examples, for mode 1 operation, a second network entity (e.g., LMF) may suggest mini slot configurations (e.g., a listing of mini slot configurations) to the first network entity (e.g., network entity 1320) for the sidelink positioning. In some examples, after the first network entity (e.g., gNB) receives the suggested mini slot configurations from the second network entity (e.g., LMF), the first network entity may configure at least one mini slot for sidelink positioning according to at least some of the suggested mini slot configurations.

Also for mode 1 operation, in some examples, the AD (e.g., which may be utilized for the configuration of the positioning resources) may include a field to specify whether the AD is applicable on a slot level or on a mini slot level. For example, if the field specifies that the AD is applicable on a slot level, then all of the configuration of the mini slots within the slot configuration will be the same and, as such, the mini slots will be repetitions of the first mini slot in the slot configuration. Conversely, if the field specifies that the AD is applicable on a mini slot level, then the configuration of each mini slot may be unique from one another. In some examples, the second network entity (e.g., LMF) may transmit the AD to the first network entity (e.g., network entity 1320) and/or the Tx UE (e.g., Tx UE 1330a).

In one or more examples, for mode 1 operation, the Tx UE (e.g., Tx UE 1330a) may be operating in, for example, the one, two, or three mini slot configurations. In one or more examples, for the assignment of the mini slots for the sidelink positioning, the positioning resource configuration is repeated within the mini slots of the slot configuration. For example, each mini slot (e.g., mini slot 1, mini slot 2, mini slot 3) within the slot structure may include the same positioning resource allocation. In one or more examples, the second network entity (e.g., LMF) may transmit to the Tx UE (e.g., Tx UE 1330a) information regarding the repeating mini slot configuration to be used by the Tx UE (e.g., Tx UE 1330a) for the positioning. In one or more examples, the second network entity (e.g., LMF) may employ a “muting pattern type configuration” in the information to indicate the enabling or disabling of each of the mini slots within the repeating mini slot configuration. In one or more examples, the “muting pattern type configuration” may be used to indicate the enabling or disabling of the mini slots on a mini slot level or on a slot level. For example, when the “muting pattern type configuration” is indicating the enabling or disabling of the mini slots on a mini slot level, the information may use a code of {minislot 1, minislot 2, minislot 3} to indicate that all three mini slots that are within the slot (e.g., slot 0) are enabled to be transmitted. Also for example, when the “muting pattern type configuration” is indicating the enabling or disabling of the mini slots on a slot level, the information may use a code of {slot 0} to indicate that all three mini slots (e.g., mini slot 1, mini slot 2, mini slot 3) that are in the slot (e.g., slot 0) are enabled to be transmitted.

Also for mode 1 operation, in one or more examples, a positioning resource configuration (e.g., PRS configuration, such as a SL PRS configuration) for each of the mini slots in a slot configuration may be independent from each other and, as such, each of the mini slots may have a different positioning resource configuration than the other mini slots within the slot configuration. In one or more examples, a second network entity (e.g., LMF) may provide a separate configuration for each of the mini slots separately. For example, the second network entity may use a code of {SLPRS1} to specify the positioning resource configuration (e.g., PRS configuration, such as a SL PRS configuration) for a first mini slot (e.g., mini slot 1) in a slot configuration, {SLPRS2} to specify the positioning resource configuration for a second mini slot (e.g., mini slot 2) in the slot configuration, and/or {SLPRS3} to specify the positioning resource configuration for a third mini slot (e.g., mini slot 3) in the slot configuration.

As previously mentioned, in 5G NR, the configuration of a slot format can be done in a static, semi-static, or fully dynamic fashion. In one or more examples, for mode 1 operation, a positioning resource configuration (e.g., PRS configuration, such as a SL PRS configuration) can be configured on a per mini slot basis statically using the AD, which is data that can be used for the configuration of the positioning resources for sidelink positioning.

For mode 2 operation, a Tx UE (e.g., a mobile device such as a smart phone, XR device, smart watch, or vehicle), such as Tx UE 1330a, may autonomously (e.g., without base station involvement) determine positioning resources (e.g., determining a resource pool of positioning resources) for its own transmissions for positioning purposes based on channel sensing. In one or more examples, the Tx UE (e.g., Tx UE 1330a) may perform channel sensing by transmitting and/or receiving channel sensing signals. In some examples, the Tx UE may use SCI to indicate to an Rx UE (e.g., a mobile device, XR device, smart watch, or vehicle), such as Rx UE 1330b, which specific slots contain the sidelink transmissions sent from the Tx UE. In one or more examples, the Tx UE may use the “time resource assignment” information field in the SCI to indicate to the Rx UE which slots contain the sidelink transmissions. The SCI also includes a “resource reservation period” information field. In some examples, the Tx UE may utilize the “resources reservation period” information field in the SCI to reserve multiple slots at one of the periodicities allowed by the slot configuration. The reserved slots may be configured for new transmission positioning resources (e.g., Tx PRS resources).

In one or more examples, for mode 2 operation, a Tx UE (e.g., Tx UE 1330a) may reserve multiple mini slots in at least one slot configuration for a “resource reservation period.” The “resource reservation period” is a period of time for one or more slots, which may contain multiple mini slots, that are utilized to perform the sidelink positioning session. In some examples, these multiple reserved mini slots may be configured in the same ordered place in their respective slots (e.g., all of the reserved mini slots are the first mini slots of each of the slots in the resource reservation period).

For mode 2 operation, in some examples, the SCI (e.g., which may be utilized for the configuration of the positioning resources) may include an additional field to specify the whether the positioning resource (e.g., PRS resource) reservations are applicable on a mini slot level (e.g., as opposed to a slot level). In one or more examples, the SCI, such as SCI-2 standard, may include an additional field to specify whether the positioning resource (e.g., PRS resource) reservations are applicable on a slot level or on a mini slot level. In other examples, the SCI, such as SCI-2 standard, may include an additional field to indicate if all of the positioning resource (e.g., PRS resource) reservations for mini slots are enabled or disabled. In some examples, different mini slots of the slot configuration may be enabled to be transmitted from the Tx UE (e.g., Tx UE 1330a) to different Rx UEs (e.g., Rx UEs 1330b, 1330c). As such, all of the Rx UEs (e.g., Rx UEs 1330b, 1330c) need not decode all of the mini slots at all of the times.

In one or more examples, for mode 2 operation, a Tx UE (e.g., Tx UE 1330a) may operate on specific mini slot configurations of the slot configurations. In some examples, the Tx UE (e.g., Tx UE 1330a) may transmit broadcast and/or multicast messages to the Rx UEs (e.g. Rx UEs 1330b, 1330c). In one or more examples, an “anchor UE” (e.g., a UE operating as a coordination UE) may ensure that all of the other participating UEs (e.g., UEs that are participating in the sidelink positioning session) utilize the same mini-slot configuration for the sidelink positioning session. In some examples, the anchor UE may provide a time “T,” for which all of the other participating UEs need to start to utilize the same mini-slot configuration for the sidelink positioning session.

As previously mentioned, the system 1300 of FIG. 13A utilizes a hybrid of mode 1 and mode 2 operation. During operation of the system 1300 of FIG. 13A, for a mode 1 operation, the first network entity (e.g., a base station, such as a gNB or eNB, or a network server) 1320 may transmit a slot indication signal 1340 to the transmit Tx UE (e.g., a mobile device, XR device, network-connected watch, or vehicle) 1330a to indicate to the Tx UE 1330a to use a slot (e.g., slot 1303 of FIG. 13D) for the Tx UE's sidelink transmissions (e.g., the first network entity 1320 may indicate a sidelink transmit grant). For example, the first network entity 1320 may indicate to the Tx UE 1330a to use a specific slot for its sidelink transmissions.

After the Tx UE 1330a receives the slot indication signal 1340, the Tx UE 1330a, for a mode 2 operation, may choose which specific mini slots within the designated slot to use for sidelink transmissions to the Rx UEs 1330b, 1330c. For example, the Tx UE 1330a may choose mini slot 1 (e.g., mini slot 1 1310a of slot 1303 of FIG. 13D) of the designated slot (e.g., slot 1303 of FIG. 13D) to transmit sidelink transmissions to Rx UE 1330b, and may choose mini slot 2 (e.g., mini slot 2 1310b of slot 1303 of FIG. 13D) of the designated slot (e.g., slot 1303 of FIG. 13D) to transmit sidelink transmissions to Rx UE 1330b. After the Tx UE 1330a chooses the particular mini slots to be transmitted for sidelink transmissions to the Rx UEs 1330b, 1330c, the Tx UE 1330a may then transmit a first sidelink signal 1341 including mini slot 1 (e.g., mini slot 1 1310a of slot 1303 of FIG. 13D) to Rx UE 1303b and transmit a second sidelink signal 1342 including mini slot 2 (e.g., mini slot 2 1310b of slot 1303 of FIG. 13D) to Rx UE 1330c for sidelink positioning.

FIG. 13B is diagram illustrating an example of a system 1301 for providing mini slots for sidelink positioning, where a network entity (e.g., base station) 1320 assigns a specific mini slot (e.g., mini slot 2 1310b of slot 1303 of FIG. 13D) for a Tx UE 1330d to transmit to a Rx UE 1330e, according to some aspects of the present disclosure. In FIG. 13B, the system 1301 is shown to include a first network entity (e.g., a base station, such as a gNB or eNB, or a network server) 1320, a Tx UE (e.g., a mobile device, XR device, network-connected watch, or vehicle) 1330d, and an Rx UE (e.g., a mobile device, XR device, network-connected watch, or vehicle) 1330e. In addition, in one or more examples, the Tx UE 1330d and the Rx UE 1330e may be equipped with heterogeneous capability, which may include, but is not limited to, C-V2X/DSRC capability, 4G/5G cellular connectivity, GPS capability, camera capability, or other sensor-based capability (e.g., light or sound-based sensors such as a depth sensor using any suitable technology for determining depth).

The system 1300 of FIG. 13B utilizes a mode 1 operation. During operation of the system 1301 of FIG. 13B, for a mode 1 operation, the first network entity (e.g., a base station) 1320 may transmit a mini slot indication signal 1343 to the transmit Tx UE 1330d to indicate to the Tx UE 1330d to use a specific mini slot (e.g., mini slot 2 1310b of slot 1303 of FIG. 13D) for the Tx UE's sidelink transmissions. For example, the first network entity 1320 may indicate to the Tx UE 1330b to use a specific mini slot for its sidelink transmissions.

After the Tx UE 1330d receives the mini slot indication signal 1343, the Tx UE 1330d, for a mode 1 operation, may then transmit a sidelink signal 1344 including mini slot 2 (e.g., mini slot 2 1310b of slot 1303 of FIG. 13D) to Rx UE 1303e for sidelink positioning.

FIG. 13C is diagram illustrating an example of a system 1302 for providing mini slots for sidelink positioning, where a network entity (e.g., base station) 1320 instructs a Tx UE 1330f to use slot (e.g., slot 1303 of FIG. 13D) including mini slots (e.g., mini slot 1 1310a, mini slot 2 1310b, and mini slot 3 1310c of FIG. 13D) to transmit to a Rx UE 1330g, according to some aspects of the present disclosure. In FIG. 13C, the system 1302 is shown to include a first network entity (e.g., a base station, such as a gNB or eNB, or a network server) 1320, a Tx UE (e.g., a mobile device, XR device, network-connected watch, or vehicle) 1330f, and an Rx UE (e.g., a mobile device, XR device, network-connected watch, or vehicle) 1330g. In addition, in one or more examples, the Tx UE 1330f and the Rx UE 1330g may be equipped with heterogeneous capability, which may include, but is not limited to, C-V2X/DSRC capability, 4G/5G cellular connectivity, GPS capability, camera capability, or other sensor-based capability (e.g., light or sound-based sensors such as a depth sensor using any suitable technology for determining depth).

The system 1302 of FIG. 13C utilizes a mode 1 operation. During operation of the system 1302 of FIG. 13C, for a mode 1 operation, the first network entity (e.g., a base station) 1320 may transmit a slot indication signal 1345 to the transmit Tx UE 1330f to indicate to the Tx UE 1330f to use a specific slot (e.g., slot 1303 of FIG. 13D) for the Tx UE's sidelink transmissions. For example, the first network entity 1320 may indicate to the Tx UE 1330f to use a specific slot for its sidelink transmissions.

After the Tx UE 1330f receives the slot indication signal 1345, the Tx UE 1330f, for a mode 1 operation, may then transmit a sidelink signal 1346 that includes all of the mini slots (e.g., mini slot 1 1310a, mini slot 2 1310b, and mini slot 3 1310c of FIG. 13D) of the designated slot (e.g., slot 1303 of FIG. 13D) to the Rx UE 1303g for sidelink positioning. In one or more examples, all of the mini slots (e.g., mini slot 1 1310a, mini slot 2 1310b, and mini slot 3 1310c of FIG. 13D) have the same positioning resource configuration (e.g., PRS resource configuration) and, as such, the positioning resource configuration repeats with the transmission of the mini slots (e.g., mini slot 1 1310a, mini slot 2 1310b, and mini slot 3 1310c of FIG. 13D).

FIG. 13D is a diagram illustrating an example of a slot structure 1303 including mini slots 1310a, 1310b, 1310c that may be employed by the systems 1300, 1301, 1302 of FIGS. 13A, 13B, and 13C, according to some aspects of the present disclosure. In FIG. 13D, the slot structure 1303 is arranged with the time domain on the horizontal (or x-) axis and the frequency domain on the vertical (or y-) axis. The slot structure 1302 may be one slot long in time (e.g., 1 ms in time). The slot structure 1303 of FIG. 13D may be employed for performing positioning (e.g., sidelink positioning). In one or more examples, the slot structure 1303 of FIG. 13D may include more or less than three mini slots 1310a, 1310b, 1310c, than as is shown in FIG. 13D.

In FIG. 13D, the slot structure 1303 is shown to include three mini slots, which include a first mini slot (e.g., mini slot 1) 1310a, a second mini slot (e.g., mini slot 2) 1310b, and a third mini slot (e.g., mini slot 3) 1310c. Each of the mini slots 1310a, 1310b, 1310c of the slot structure 1303 is shown to include an AGC resource 1312a, 1312b, 1312c. Each of the mini slots 1310a, 1310b, 1310c of the slot structure 1303 is also shown to include blank symbols (e.g., three blank symbols). In one or more examples, these blank symbols in the mini slots 1310a, 1310b, 1310c may include various different types of resources (e.g., positioning resources, such as SL PRS resources, and/or control channel resources, such as a PSCCH). In one or more examples, the mini slots 1310a, 1310b, 1310c of the slot structure 1303 of FIG. 13D may include more or less different types of resources for the symbols, than as is shown in FIG. 13D.

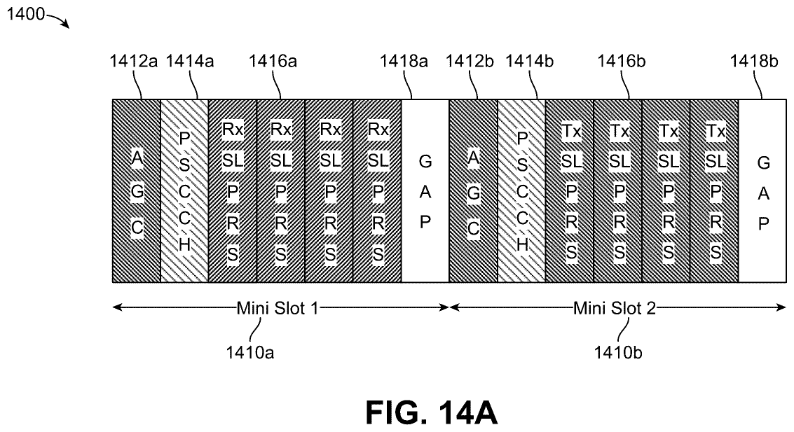

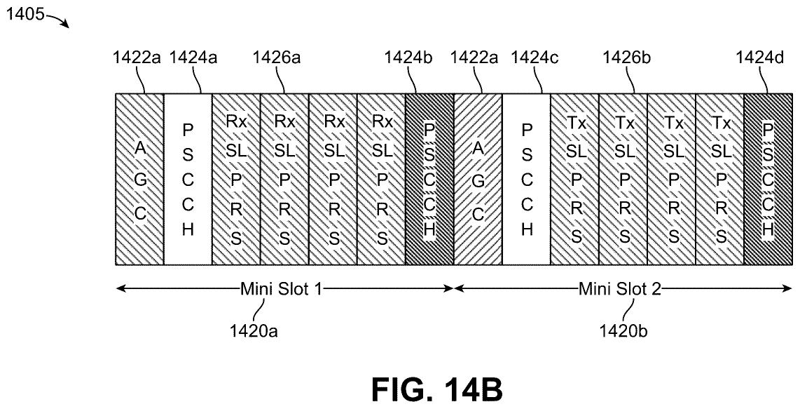

FIG. 14A is a diagram illustrating an example of a slot structure 1400 including mini slots 1410a, 1410b having gaps 1418a, 1418b such that the mini slots 1410a, 1410b are separated by a gap 1418a, 1418b, according to some aspects of the present disclosure. FIG. 14B is a diagram illustrating an example of a slot structure 1405 including mini slots 1420a, 1420b without gaps, according to some aspects of the present disclosure.

In order to enable low-latency for sidelink positioning for various different applications, different mini slots (e.g., mini slots 1410a, 1410b) within a slot structure (e.g., slot structure 1400) may include different positioning resources. For example, in FIG. 14A, the slot structure 1400 includes a first mini slot 1410a with receive PRS resources 1416a and a second mini slot 1410b with transmit PRS resources 1416b. Similarly, in FIG. 14B, the slot structure 1405 includes a first mini slot 1420a with receive PRS resources 1426a and a second mini slot 1420b with transmit PRS resources 1426b.

In FIGS. 14A and 14B, the slot structures 1400, 1405 are each arranged with the time domain on the horizontal (or x-) axis and the frequency domain on the vertical (or y-) axis. The slot structures 1400, 1405 in FIGS. 14A and 14B may each be one slot long in time (e.g., 1 ms in time). In one or more examples, the slot structures 1400, 1405 may be employed for positioning (e.g., sidelink positioning). The slot structures 1400, 1405 are each shown to include two mini slots, which include a first mini slot (e.g., mini slot 1) 1410a, 1420a and a second mini slot (e.g., mini slot 2) 1410b, 1420b. In one or more examples, the slot structures 1400, 1405 may include more mini slots than as shown in FIGS. 14A and 14B.

In FIG. 14A, each of the mini slots 1410a, 1410b of the slot structure 1400 is shown to include an automatic gain control (AGC) resource 1412a, 1412b, a control channel resource (e.g., PSCCH) 1414a, 1414b, a plurality of positioning resources (e.g., PRS resources, such as Tx PRS resource and Rx PRS resources) 1416a, 1416b, and a gap 1418a, 1418b, which is devoid of any data. Mini slot 1410a includes four positioning resources (including positioning resource 1416a), which are Rx PRS resources, in four symbols, and mini slot 1410b includes four positioning resources (including positioning resource 1416b), which are Tx PRS resources, in four symbols. In one or more examples, the mini slots 1410a, 1410b of the slot structure 1400 of FIG. 14A may include more or less positioning resources and/or include more or less different types of resources for the symbols, than as is shown in FIG. 14A.

In one or more examples, when a slot structure (e.g., slot structure 1400) is employed for positioning purposes (e.g., sidelink positioning) and when consecutive mini slots (e.g., mini slots 1410a, 1410b) are configured to have different positioning resources (e.g., one mini slot has transmit positioning resources, and an adjacent mini slot has receive positioning resources), gaps (e.g., gaps 1418a, 1418b) may be implemented within the mini slots (e.g., mini slots 1410a, 1410b) of the slot structure (e.g., slot structure 1400). The gaps (e.g., gaps 1418a, 1418b) are intentionally placed at the end of each of the mini slots (e.g., mini slots 1410a, 1410b) such that the gaps (e.g., gaps 1418a, 1418b) are positioned between the adjacent mini slots (e.g., mini slots 1410a, 1410b) to prevent any possible interference caused by the switching of the different positioning resources. In some examples, when a slot structure is employed for positioning purposes (e.g., sidelink positioning) and when consecutive mini slots are configured to have the same positioning resources (e.g., one mini slot has receive positioning resources, and an adjacent mini slot also has receive positioning resources), gaps (e.g., gaps 1418a, 1418b) do not need to be implemented within the mini slots of the slot structure. In cases where gaps are not needed, a positioning resource (e.g., a transmit positioning resource or a receive positioning resource) or a measurement report may be implemented within the gap symbol. Such a configuration allows additional resources to be included within a mini slot.

It should also be noted that, in one or more examples, when a slot structure (e.g., slot structure 1400) is employed for sidelink (SL) data transfer purposes, gaps (e.g., gaps 1418a, 1418b) may be implemented within the mini slots (e.g., mini slots 1410a, 1410b) of the slot structure (e.g., slot structure 1400) such that the gaps (e.g., gaps 1418a, 1418b) are positioned between adjacent mini slots (e.g., mini slots 1410a, 1410b).

In FIG. 14B, each of the mini slots 1420a, 1420b of the slot structure 1405 is shown to include an automatic gain control (AGC) resource 1422a, 1422b, two control channel resources (e.g., a PSCCH) 1424a, 1424b, 1424c, 1424d, and a plurality of positioning resources (e.g., PRS resources, such as Tx PRS resource and Rx PRS resources) 1426a, 1426b. Mini slot 1420a includes four positioning resources (including positioning resource 1426a), which are Rx PRS resources, in four symbols, and mini slot 1420b includes four positioning resources (including positioning resource 1426b), which are Tx PRS resources, in four symbols. The mini slots 1420a, 1420b of the slot structure 1405 of FIG. 14B may include more or less positioning resources, more or less control channel resources, and/or include more or less different types of resources for the symbols, than as is shown in FIG. 14B.

It should be noted that, in one or more examples, when a slot structure is employed for positioning purposes (e.g., sidelink positioning) and when consecutive mini slots are configured to the same positioning resources (e.g., one mini slot has receive positioning resources, and an adjacent mini slot also has receive positioning resources), gaps are not needed within the mini slots of the slot structure. In cases where gaps are not needed, a gap symbol may be used for a receive positioning resource (e.g., Rx PRS), a transmit positioning resource (e.g., Tx PRS), or a measurement report.

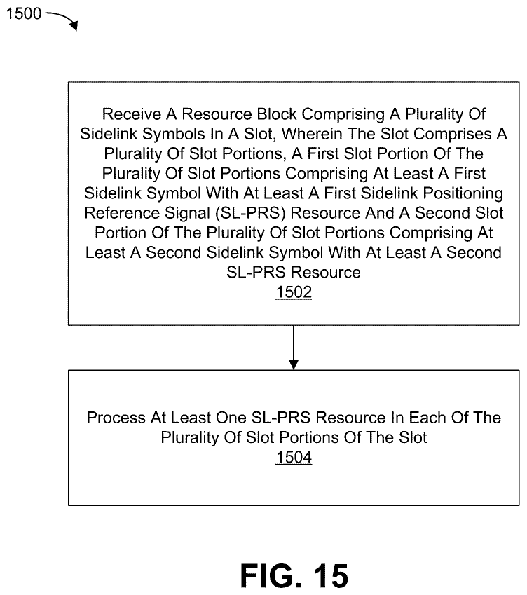

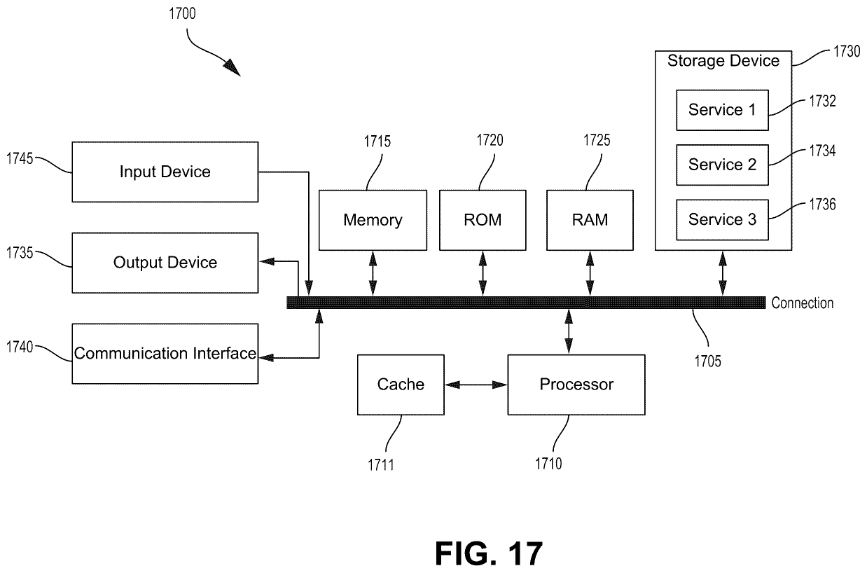

FIG. 15 is a flow chart illustrating an example of a process 1500 for wireless communications, such as for performing sidelink positioning. The process 1500 can be performed by a UE (e.g., a mobile device, a network-connected wearable device such as a watch, extended reality glasses, vehicle, etc.) or by a component or system (e.g., a chipset) of the UE. The operations of the process 1500 may be implemented as software components that are executed and run on one or more processors (e.g., control system 352 of FIG. 3, processor(s) 484 of FIG. 4, DSP(s) 482 of FIG. 4, processor 1710 of FIG. 17, or other processor(s)). Further, the transmission and reception of signals by the wireless communications device in the process 1500 may be enabled, for example, by one or more antennas (e.g., one or more antennas of the of the vehicle computing system 300 of FIG. 3, antenna 487 of FIG. 4, one or more antennas of the computing system 1700 of FIG. 17, or other antenna(s)), one or more transceivers (e.g., one or more wireless transceivers of the vehicle computing system 300 of FIG. 3, wireless transceiver(s) 478 of FIG. 4, one or more wireless transceivers of the computing system 1700 of FIG. 17, or other wireless transceiver(s)), one or more modems (e.g., one or more modems of the of the vehicle computing system 300 of FIG. 3, the modem(s) 476 of FIG. 4, one or more modems of the computing system 1700 of FIG. 17, or other modem(s)), and/or other reception and/or transmission components.

At block 1502, the UE (or component thereof) may receive a resource block including a plurality of sidelink symbols in a slot. In some cases, the resource block is received for a resource reservation period, as described herein. The slot includes a plurality of slot portions (also referred to as mini slots herein, such as mini slot 1010a and mini slot 1010b of FIG. 10A, mini slot 1020a and mini slot 120b of FIG. 10B, mini slot 1120a and mini slot 1120b of FIG. 11A, mini slot 1210a, mini slot 1210b, and mini slot 1210c of FIG. 12A, etc.). For instance, a first slot portion (e.g., mini slot 1120a of FIG. 11A) of the plurality of slot portions may include at least a first sidelink symbol with at least a first sidelink positioning reference signal (SL-PRS) resource (e.g., Rx SL-PRS 1126a) and a second slot portion (e.g., mini slot 1120b of FIG. 11A) of the plurality of slot portions comprising at least a second sidelink symbol with at least a second SL-PRS resource (e.g., Tx SL-PRS 1126b). In some cases, the first SL-PRS resource includes a transmit PRS or a receive PRS and the second SL-PRS resource comprises a transmit PRS or a receive PRS. For instance, referring to FIG. 11B as an illustrative example, the mini slot 1130a includes an Rx SL-PRS 1136a and the mini slot 1130a includes a Tx SL-PRS 1136b.

In some aspects, the first slot portion includes a sidelink control channel resource (e.g., a physical sidelink control channel (PSCCH) resource). In such aspects, the second slot portion may or may not include a sidelink control channel resource. For example, in some cases, the first and second slot portions include a sidelink control channel resource (e.g., the first slot portion includes a first sidelink control channel resource and the second slot portion includes a second sidelink control channel resource). For instance, referring to FIG. 11A as an illustrative example, the mini slot 1120a includes a PSCCH 1124a and the mini slot 1120b includes a PSCCH 1124b. In some cases, the first slot portion includes a sidelink control channel resource (e.g., a PSCCH resource) and the second slot portion does not include a sidelink control channel resource. For instance, referring to FIG. 11B as an illustrative example, the mini slot 1130a includes a PSCCH 1134 and the mini slot 1130b does not include a PSCCH or other sidelink control channel resource.

In some aspects, the sidelink control channel resource (e.g., the PSCCH) is frequency division multiplexed with the first SL-PRS resource or the second SL-PRS resource. For instance, referring to FIG. 10B as an illustrative example, the PSCCH 1024a is frequency division multiplexed with two Rx SL-PRSs, including Rx SL-PRS 1026a. In some aspects, neither the first slot portion nor the second slot portion include a sidelink control channel resource (e.g., both the first slot portion and the second slot portion do not include a sidelink control channel resource). For instance, referring to FIG. 11C as an illustrative example, neither the mini slot 1140a nor the mini slot 1140b include any PSCCH resources or other sidelink control channel resources.

In some aspects, the first slot portion and/or the second slot portion include an automatic gain control (AGC) resource. For instance, the first slot portion may include a first automatic gain control (AGC) resource and the second slot portion may include a second AGC resource. Referring to FIG. 11C as an illustrative example, the mini slot 1140a includes AGC resource 1142a and the mini slot 1140b includes AGC resource 1142b.

In some cases, the first slot portion and/or the second slot portion includes a gap (e.g., a symbol without data). For instance, the first slot portion may include a first gap (e.g., a first symbol without data) and the second slot portion may include a second gap (e.g., a second symbol without data). Referring again referring to FIG. 11C as an illustrative example, the mini slot 1140a includes gap 1148a and the mini slot 1140b includes gap 1148b.

In some aspects, a SL-PRS resource configuration is repeated in the plurality of slot portions of the slot. For instance, referring to FIG. 12C as an illustrative example, the SL-PRS resource configuration is repeated in each of the mini slots 1230a, 1230b, 1230c, 1240a, 1240b, and 1240c (e.g., the SL PRSs are included in the final two symbols of each of the mini slots).

At block 1504, the UE (or component thereof) may process at least one SL-PRS resource in each of the plurality of slot portions of the slot. In some aspects, the UE (or component thereof) may transmit, to a network entity, information associated with an application of at least one of the plurality of slot portions of the slot for sidelink (SL) positioning and/or information associated with a configuration of the plurality of slot portions of the slot for a resource reservation period, such as that described above with respect to the two modes of operation (mode 1 and mode 2) for positioning in association with FIG. 13A-FIG. 13C. In some cases, the UE (or component thereof) may receive, from a network entity, a configuration for at least one of the plurality of slot portions of the slot for sidelink positioning. For example, as described above with respect to the two modes of operation (mode 1 and mode 2) for positioning in association with FIG. 13A-FIG. 13C, the configuration may be based on a list of recommended configurations from an additional network entity for at least one of the plurality of slot portions of the slot for sidelink positioning. In one illustrative example, the network entity is a base station and the additional network entity is a location server.

In some aspects, the UE (or component thereof) may receive, from a network entity, information associated with a SL-PRS resource configuration for each of the plurality of slot portions of the slot. In some cases, the information is an indication of one or more slot portions of the plurality of slot portions of the slot that are enabled or disabled for one or more SL-PRS resources. In some examples, the information is included as part of assistance data (AD). In some cases, the information specifies the SL-PRS resource configuration on at least one of a slot portion level or a slot level. In some cases, the SL-PRS resource configuration is independent for each of the plurality of slot portions of the slot.

In some aspects, the UE (or component thereof) may transmit sidelink control information (SCI) to a receive UE. For example, the SCI may include information related to a SL-PRS resource configuration for each of the plurality of slot portions of the slot. In some cases, the information specifies the SL-PRS resource configuration on at least one of a slot portion level or a slot level. In some examples, the information is an indication of one or more slot portions of the plurality of slot portions of the slot that are enabled or disabled for one or more SL-PRS resources.

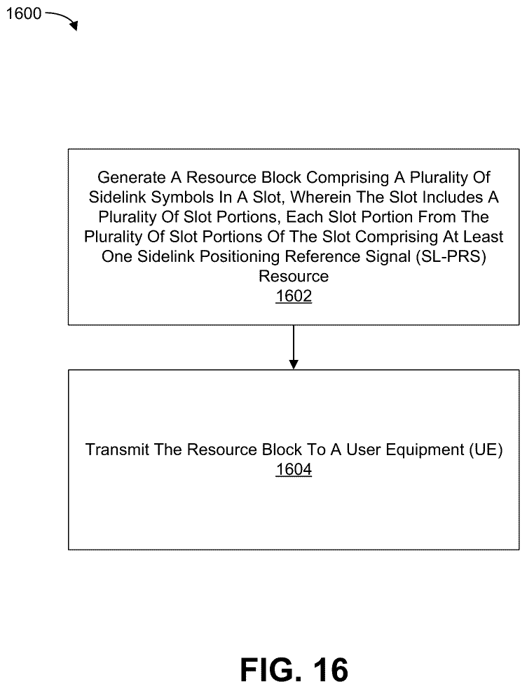

FIG. 16 is a flow chart illustrating an example of a process 1600 for wireless communications. The process 1600 can be performed by a UE (e.g., a mobile device, a network-connected wearable device such as a watch, extended reality glasses, vehicle, etc.) or by a component or system (e.g., a chipset) of the UE. The operations of the process 1500 may be implemented as software components that are executed and run on one or more processors (e.g., control system 352 of FIG. 3, processor(s) 484 of FIG. 4, DSP(s) 482 of FIG. 4, processor 1710 of FIG. 17, or other processor(s)). Further, the transmission and reception of signals by the wireless communications device in the process 1500 may be enabled, for example, by one or more antennas (e.g., one or more antennas of the of the vehicle computing system 300 of FIG. 3, antenna 487 of FIG. 4, one or more antennas of the computing system 1700 of FIG. 17, or other antenna(s)), one or more transceivers (e.g., one or more wireless transceivers of the vehicle computing system 300 of FIG. 3, wireless transceiver(s) 478 of FIG. 4, one or more wireless transceivers of the computing system 1700 of FIG. 17, or other wireless transceiver(s)), one or more modems (e.g., one or more modems of the of the vehicle computing system 300 of FIG. 3, the modem(s) 476 of FIG. 4, one or more modems of the computing system 1700 of FIG. 17, or other modem(s)), and/or other reception and/or transmission components

At block 1602, the UE (or component thereof) may generate a resource block including a plurality of sidelink symbols in a slot. In some cases, the resource block is generated for a resource reservation period, as described herein. The slot includes a plurality of slot portions (also referred to as mini slots herein, such as mini slot 1010a and mini slot 1010b of FIG. 10A, mini slot 1020a and mini slot 120b of FIG. 10B, mini slot 1120a and mini slot 1120b of FIG. 11A, mini slot 1210a, mini slot 1210b, and mini slot 1210c of FIG. 12A, etc.). Each slot portion from the plurality of slot portions of the slot includes at least one sidelink positioning reference signal (SL-PRS) resource. For instance, a first slot portion (e.g., mini slot 1120a of FIG. 11A) of the plurality of slot portions may include at least a first sidelink symbol with at least a first sidelink positioning reference signal (SL-PRS) resource (e.g., Rx SL-PRS 1126a) and a second slot portion (e.g., mini slot 1120b of FIG. 11A) of the plurality of slot portions comprising at least a second sidelink symbol with at least a second SL-PRS resource (e.g., Tx SL-PRS 1126b). In some cases, the first SL-PRS resource includes a transmit PRS or a receive PRS and the second SL-PRS resource comprises a transmit PRS or a receive PRS. For instance, referring to FIG. 11B as an illustrative example, the mini slot 1130a includes an Rx SL-PRS 1136a and the mini slot 1130a includes a Tx SL-PRS 1136b.

In some aspects, the first slot portion includes a sidelink control channel resource (e.g., a physical sidelink control channel (PSCCH) resource). In such aspects, the second slot portion may or may not include a sidelink control channel resource. For example, in some cases, the first and second slot portions include a sidelink control channel resource (e.g., the first slot portion includes a first sidelink control channel resource and the second slot portion includes a second sidelink control channel resource). For instance, referring to FIG. 11A as an illustrative example, the mini slot 1120a includes a PSCCH 1124a and the mini slot 1120b includes a PSCCH 1124b. In some cases, the first slot portion includes a sidelink control channel resource (e.g., a PSCCH resource) and the second slot portion does not include a sidelink control channel resource. For instance, referring to FIG. 11B as an illustrative example, the mini slot 1130a includes a PSCCH 1134 and the mini slot 1130b does not include a PSCCH or other sidelink control channel resource.

In some aspects, the sidelink control channel resource (e.g., the PSCCH) is frequency division multiplexed with the first SL-PRS resource or the second SL-PRS resource. For instance, referring to FIG. 10B as an illustrative example, the PSCCH 1024a is frequency division multiplexed with two Rx SL-PRSs, including Rx SL-PRS 1026a. In some aspects, neither the first slot portion nor the second slot portion include a sidelink control channel resource (e.g., both the first slot portion and the second slot portion do not include a sidelink control channel resource). For instance, referring to FIG. 11C as an illustrative example, neither the mini slot 1140a nor the mini slot 1140b include any PSCCH resources or other sidelink control channel resources.

In some aspects, the first slot portion and/or the second slot portion include an automatic gain control (AGC) resource. For instance, the first slot portion may include a first automatic gain control (AGC) resource and the second slot portion may include a second AGC resource. Referring to FIG. 11C as an illustrative example, the mini slot 1140a includes AGC resource 1142a and the mini slot 1140b includes AGC resource 1142b.

In some cases, the first slot portion and/or the second slot portion includes a gap (e.g., a symbol without data). For instance, the first slot portion may include a first gap (e.g., a first symbol without data) and the second slot portion may include a second gap (e.g., a second symbol without data). Referring again referring to FIG. 11C as an illustrative example, the mini slot 1140a includes gap 1148a and the mini slot 1140b includes gap 1148b.

In some aspects, a SL-PRS resource configuration is repeated in the plurality of slot portions of the slot. For instance, referring to FIG. 12C as an illustrative example, the SL-PRS resource configuration is repeated in each of the mini slots 1230a, 1230b, 1230c, 1240a, 1240b, and 1240c (e.g., the SL PRSs are included in the final two symbols of each of the mini slots).

At block 1604, the UE (or component thereof) may transmit the resource block to a second UE. In some aspects, the UE (or component thereof) may transmit, to a network entity, information associated with an application of at least one of the plurality of slot portions of the slot for sidelink (SL) positioning and/or information associated with a configuration of the plurality of slot portions of the slot for a resource reservation period, such as that described above with respect to the two modes of operation (mode 1 and mode 2) for positioning in association with FIG. 13A-FIG. 13C. In some cases, the UE (or component thereof) may receive, from a network entity, a configuration for at least one of the plurality of slot portions of the slot for sidelink positioning. For example, as described above with respect to the two modes of operation (mode 1 and mode 2) for positioning in association with FIG. 13A-FIG. 13C, the configuration may be based on a list of recommended configurations from an additional network entity for at least one of the plurality of slot portions of the slot for sidelink positioning. In one illustrative example, the network entity is a base station and the additional network entity is a location server.

In some aspects, the UE (or component thereof) may receive, from a network entity, information associated with a SL-PRS resource configuration for each of the plurality of slot portions of the slot. In some cases, the information is an indication of one or more slot portions of the plurality of slot portions of the slot that are enabled or disabled for one or more SL-PRS resources. In some examples, the information is included as part of assistance data (AD). In some cases, the information specifies the SL-PRS resource configuration on at least one of a slot portion level or a slot level. In some cases, the SL-PRS resource configuration is independent for each of the plurality of slot portions of the slot.

In some aspects, the UE (or component thereof) may transmit sidelink control information (SCI) to a receive UE. For example, the SCI may include information related to a SL-PRS resource configuration for each of the plurality of slot portions of the slot. In some cases, the information specifies the SL-PRS resource configuration on at least one of a slot portion level or a slot level. In some examples, the information is an indication of one or more slot portions of the plurality of slot portions of the slot that are enabled or disabled for one or more SL-PRS resources.

FIG. 17 is a diagram illustrating an example of a system for implementing certain aspects of the present technology. In particular, FIG. 17 illustrates an example of computing system 1700, which can be for example any computing device making up internal computing system, a remote computing system, a camera, or any component thereof in which the components of the system are in communication with each other using connection 1705. Connection 1705 can be a physical connection using a bus, or a direct connection into processor 1710, such as in a chipset architecture. Connection 1705 can also be a virtual connection, networked connection, or logical connection.

In some aspects, computing system 1700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1700 includes at least one processing unit (CPU or processor) 1710 and connection 1705 that couples various system components including system memory 1715, such as read-only memory (ROM) 1720 and random-access memory (RAM) 1725 to processor 1710. Computing system 1700 can include a cache 1711 of high-speed memory connected directly with, in close proximity to, or integrated as part of processor 1710.

Processor 1710 can include any general-purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric. In one or more examples, the processor 1710 may perform each of the blocks of the algorithm in the aforementioned flowchart of FIG. 16.

The computing system 1700 may include additional components that perform each of the blocks of the algorithm in the aforementioned flowchart of FIG. 16. As such, each block in the aforementioned flowchart of FIG. 16 may be performed by a component, and the computing system 1700 may include one or more of those components. The components may be one or more hardware components specifically configured to carry out the stated processes/algorithm, implemented by a processor (e.g., processor 1710) configured to perform the stated processes/algorithm, stored within a computer-readable medium for implementation by a processor, or some combination thereof.

To enable user interaction, computing system 1700 includes an input device 1745, which can represent any number of input mechanisms, such as a microphone for speech, a touch-sensitive screen for gesture or graphical input, keyboard, mouse, motion input, speech, etc. Computing system 1700 can also include output device 1735, which can be one or more of a number of output mechanisms. In some instances, multimodal systems can enable a user to provide multiple types of input/output to communicate with computing system 1700. Computing system 1700 can include communications interface 1740, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1740 may also include one or more GNSS receivers or transceivers that are used to determine a location of the computing system 1700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1730 can include software services, servers, services, etc., that when the code that defines such software is executed by the processor 1710, it causes the system to perform a function. In some aspects, a hardware service that performs a particular function can include the software component stored in a computer-readable medium in connection with the necessary hardware components, such as processor 1710, connection 1705, output device 1735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may include memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: An apparatus for performing sidelink positioning, comprising: at least one memory; and at least one processor coupled to the at least one memory, the at least one processor configured to: receive a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and process at least one SL-PRS resource in each of the plurality of slot portions of the slot.

Aspect 2: The apparatus of Aspect 1, wherein the at least one processor is configured to receive the resource block for a resource reservation period.

Aspect 3: The apparatus of any of Aspects 1 or 2, wherein the first SL-PRS resource comprises one of a transmit PRS or a receive PRS, and wherein the second SL-PRS resource comprises one of a transmit PRS or a receive PRS.

Aspect 4: The apparatus of any of Aspects 1 to 3, wherein at least one of the first slot portion or the second slot portion comprises a sidelink control channel resource.

Aspect 5: The apparatus of Aspect 4, wherein the sidelink control channel resource is a physical sidelink control channel (PSCCH) resource.

Aspect 6: The apparatus of any of Aspects 4 or 5, wherein the sidelink control channel resource is frequency division multiplexed with the first SL-PRS resource or the second SL-PRS resource.

Aspect 7: The apparatus of any of Aspects 1 to 6, wherein the first slot portion comprises a first sidelink control channel resource, and wherein the second slot portion comprises a second sidelink control channel resource.

Aspect 8: The apparatus of any of Aspects 1 to 7, wherein both the first slot portion and the second slot portion do not comprise a sidelink control channel resource.

Aspect 9: The apparatus of any of Aspects 1 to 8, wherein one of the first slot portion or the second slot portion comprises an automatic gain control (AGC) resource.

Aspect 10: The apparatus of any of Aspects 1 to 9, wherein the first slot portion comprises a first automatic gain control (AGC) resource, and wherein the second slot portion comprises a second AGC resource.

Aspect 11: The apparatus of any of Aspects 1 to 10, wherein one of the first slot portion or the second slot portion comprises a gap, wherein a gap is a symbol without data.

Aspect 12: The apparatus of any of Aspects 1 to 11, wherein the first slot portion comprises a first gap and the second slot portion comprises a second gap, and wherein the first gap and the second gap are each a symbol without data.

Aspect 13: The apparatus of any of Aspects 1 to 12, wherein the at least one processor is configured to: output, for transmission to a network entity, information associated with an application of at least one of the plurality of slot portions of the slot for sidelink (SL) positioning.

Aspect 14: The apparatus of any of Aspects 1 to 13, wherein the at least one processor is configured to: output, for transmission to a network entity, information associated with a configuration of the plurality of slot portions of the slot for a resource reservation period.

Aspect 15: The apparatus of any of Aspects 1 to 14, wherein the at least one processor is configured to: receive, from a network entity, a configuration for at least one of the plurality of slot portions of the slot for sidelink positioning.

Aspect 16: The apparatus of Aspect 15, wherein the configuration is based on a list of recommended configurations from an additional network entity for at least one of the plurality of slot portions of the slot for sidelink positioning.

Aspect 17: The apparatus of Aspect 16, wherein the network entity is a base station and the additional network entity is a location server.

Aspect 18: The apparatus of any of Aspects 1 to 17, wherein a SL-PRS resource configuration is repeated in the plurality of slot portions of the slot.

Aspect 19: The apparatus of any of Aspects 1 to 18, wherein the at least one processor is configured to: receive, from a network entity, information associated with a SL-PRS resource configuration for each of the plurality of slot portions of the slot.

Aspect 20: The apparatus of Aspect 19, wherein the information is an indication of one or more slot portions of the plurality of slot portions of the slot that are enabled or disabled for one or more SL-PRS resources.

Aspect 21: The apparatus of any of Aspects 19 or 20, wherein the information is included as part of assistance data (AD).

Aspect 22: The apparatus of any of Aspects 19 to 21, wherein the information specifies the SL-PRS resource configuration on at least one of a slot portion level or a slot level.

Aspect 23: The apparatus of any of Aspects 19 to 22, wherein the SL-PRS resource configuration is independent for each of the plurality of slot portions of the slot.

Aspect 24: The apparatus of any of Aspects 1 to 23, wherein the at least one processor is configured to: output sidelink control information (SCI) for transmission to a receive user equipment (UE).

Aspect 25: The apparatus of Aspect 24, wherein the SCI comprises information related to a SL-PRS resource configuration for each of the plurality of slot portions of the slot.

Aspect 26: The apparatus of Aspect 25, wherein the information specifies the SL-PRS resource configuration on at least one of a slot portion level or a slot level.

Aspect 27: The apparatus of any of Aspects 25 or 26, wherein the information is an indication of one or more slot portions of the plurality of slot portions of the slot that are enabled or disabled for one or more SL-PRS resources.

Aspect 28: The apparatus of any of Aspects 1 to 27, wherein the apparatus is configured as a user equipment (UE), and further comprising: at least one transceiver configured to receive the resource block.

Aspect 29: A method for performing sidelink positioning at a user equipment (UE), comprising: receiving, at the UE, a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and processing, by the UE, at least one SL-PRS resource in each of the plurality of slot portions of the slot.

Aspect 30: The method of Aspect 29, wherein the resource block is received for a resource reservation period.

Aspect 31: The method of any of Aspects 29 or 30, wherein the first SL-PRS resource comprises one of a transmit PRS or a receive PRS, and wherein the second SL-PRS resource comprises one of a transmit PRS or a receive PRS.

Aspect 32: The method of any of Aspects 29 to 31, wherein at least one of the first slot portion or the second slot portion comprises a sidelink control channel resource.

Aspect 33: The method of Aspect 32, wherein the sidelink control channel resource is a physical sidelink control channel (PSCCH) resource.

Aspect 34: The method of any of Aspects 32 or 33, wherein the sidelink control channel resource is frequency division multiplexed with the first SL-PRS resource or the second SL-PRS resource.

Aspect 35: The method of any of Aspects 29 to 34, wherein the first slot portion comprises a first sidelink control channel resource, and wherein the second slot portion comprises a second sidelink control channel resource.

Aspect 36: The method of any of Aspects 29 to 35, wherein both the first slot portion and the second slot portion do not comprise a sidelink control channel resource.

Aspect 37: The method of any of Aspects 29 to 36, wherein one of the first slot portion or the second slot portion comprises an automatic gain control (AGC) resource.

Aspect 38: The method of any of Aspects 29 to 37, wherein the first slot portion comprises a first automatic gain control (AGC) resource, and wherein the second slot portion comprises a second AGC resource.

Aspect 39: The method of any of Aspects 29 to 38, wherein one of the first slot portion or the second slot portion comprises a gap, wherein a gap is a symbol without data.

Aspect 40: The method of any of Aspects 29 to 39, wherein the first slot portion comprises a first gap and the second slot portion comprises a second gap, and wherein the first gap and the second gap are each a symbol without data.

Aspect 41: The method of any of Aspects 29 to 40, further comprising transmitting, by the UE to a network entity, information associated with an application of at least one of the plurality of slot portions of the slot for sidelink (SL) positioning.

Aspect 42: The method of any of Aspects 29 to 41, further comprising transmitting, by the UE to a network entity, information associated with a configuration of the plurality of slot portions of the slot for a resource reservation period.

Aspect 43: The method of any of Aspects 29 to 42, further comprising receiving, at the UE from a network entity, a configuration for at least one of the plurality of slot portions of the slot for sidelink positioning.

Aspect 44: The method of Aspect 43, wherein the configuration is based on a list of recommended configurations from an additional network entity for at least one of the plurality of slot portions of the slot for sidelink positioning.

Aspect 45: The method of Aspect 44, wherein the network entity is a base station and the additional network entity is a location server.

Aspect 46: The method of any of Aspects 29 to 45, wherein a SL-PRS resource configuration is repeated in the plurality of slot portions of the slot.

Aspect 47: The method of any of Aspects 29 to 46, further comprising receiving, at the UE from a network entity, information associated with a SL-PRS resource configuration for each of the plurality of slot portions of the slot.

Aspect 48: The method of Aspect 47, wherein the information is an indication of one or more slot portions of the plurality of slot portions of the slot that are enabled or disabled for one or more SL-PRS resources.

Aspect 49: The method of any of Aspects 47 or 48, wherein the information is included as part of assistance data (AD).

Aspect 50: The method of any of Aspects 47 to 49, wherein the information specifies the SL-PRS resource configuration on at least one of a slot portion level or a slot level.

Aspect 51: The method of any of Aspects 47 to 50, wherein the SL-PRS resource configuration is independent for each of the plurality of slot portions of the slot.

Aspect 52: The method of any of Aspects 29 to 51, further comprising transmitting, by the UE, sidelink control information (SCI) to a receive UE.

Aspect 53: The method of Aspect 52, wherein the SCI comprises information related to a SL-PRS resource configuration for each of the plurality of slot portions of the slot.

Aspect 54: The method of Aspect 53, wherein the information specifies the SL-PRS resource configuration on at least one of a slot portion level or a slot level.

Aspect 55: The method of any of Aspects 53 or 54, wherein the information is an indication of one or more slot portions of the plurality of slot portions of the slot that are enabled or disabled for one or more SL-PRS resources.

Aspect 56: At least one non-transitory computer-readable medium containing instructions which, when executed by one or more processors, cause the one or more processors to perform operations according to any of Aspects 1 to 55.

Aspect 57: An apparatus comprising means for performing operations according to any of Aspects 1 to 55.

Aspect 58: An apparatus for performing sidelink positioning, comprising: at least one memory; and at least one processor coupled to the at least one memory, the at least one processor configured to: generate a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and transmit the resource block to a user equipment (UE).

Aspect 59: The apparatus of Aspect 58, wherein the at least one processor is configured to perform operations according to any of Aspects 30 to 55.

Aspect 60: A method for performing sidelink positioning at a first user equipment (UE), comprising: generating, at the first UE, a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and transmitting, from the first UE, the resource block to a second UE.

Aspect 61: The method of Aspect 60, further comprising operations according to any of Aspects 30 to 55.

Aspect 62: At least one non-transitory computer-readable medium containing instructions which, when executed by one or more processors, cause the one or more processors to: generate a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and transmit the resource block to a user equipment (UE).

Aspect 63: The at least one non-transitory computer-readable medium of Aspect 62, wherein the instructions, when executed by the one or more processors, cause the one or more processors to perform operations according to any of Aspects 30 to 55.

Aspect 64: An apparatus comprising: means for generating a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and means for transmitting the resource block to a user equipment (UE).

Aspect 65: The method of Aspect 64, further comprising means for performing operations according to any of Aspects 30 to 55.

1. An apparatus for performing sidelink positioning, comprising:
at least one memory; and
at least one processor coupled to the at least one memory, the at least one processor configured to:
receive a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and
process at least one SL-PRS resource in each of the plurality of slot portions of the slot.

2. The apparatus of claim 1, wherein the at least one processor is configured to receive the resource block for a resource reservation period.

3. The apparatus of claim 1, wherein the first SL-PRS resource comprises one of a transmit PRS or a receive PRS, and wherein the second SL-PRS resource comprises one of a transmit PRS or a receive PRS.

4. The apparatus of claim 1, wherein at least one of the first slot portion or the second slot portion comprises a sidelink control channel resource.

5. The apparatus of claim 4, wherein the sidelink control channel resource is a physical sidelink control channel (PSCCH) resource.

6. The apparatus of claim 4, wherein the sidelink control channel resource is frequency division multiplexed with the first SL-PRS resource or the second SL-PRS resource.

7. The apparatus of claim 1, wherein the first slot portion comprises a first sidelink control channel resource, and wherein the second slot portion comprises a second sidelink control channel resource.

8. The apparatus of claim 1, wherein both the first slot portion and the second slot portion do not comprise a sidelink control channel resource.

9. The apparatus of claim 1, wherein one of the first slot portion or the second slot portion comprises an automatic gain control (AGC) resource.

10. The apparatus of claim 1, wherein the first slot portion comprises a first automatic gain control (AGC) resource, and wherein the second slot portion comprises a second AGC resource.

11. The apparatus of claim 1, wherein one of the first slot portion or the second slot portion comprises a gap, wherein a gap is a symbol without data.

12. The apparatus of claim 1, wherein the first slot portion comprises a first gap and the second slot portion comprises a second gap, and wherein the first gap and the second gap are each a symbol without data.

13. The apparatus of claim 1, wherein the at least one processor is configured to:
output, for transmission to a network entity, information associated with an application of at least one of the plurality of slot portions of the slot for sidelink (SL) positioning.

14. The apparatus of claim 1, wherein the at least one processor is configured to:
output, for transmission to a network entity, information associated with a configuration of the plurality of slot portions of the slot for a resource reservation period.

15. The apparatus of claim 1, wherein the at least one processor is configured to:
receive, from a network entity, a configuration for at least one of the plurality of slot portions of the slot for sidelink positioning.

16. The apparatus of claim 15, wherein the configuration is based on a list of recommended configurations from an additional network entity for at least one of the plurality of slot portions of the slot for sidelink positioning.

17. The apparatus of claim 16, wherein the network entity is a base station and the additional network entity is a location server.

18. The apparatus of claim 1, wherein a SL-PRS resource configuration is repeated in the plurality of slot portions of the slot.

19. The apparatus of claim 1, wherein the at least one processor is configured to:
receive, from a network entity, information associated with a SL-PRS resource configuration for each of the plurality of slot portions of the slot.

20. The apparatus of claim 19, wherein the information is an indication of one or more slot portions of the plurality of slot portions of the slot that are enabled or disabled for one or more SL-PRS resources.

21. The apparatus of claim 19, wherein the information is included as part of assistance data (AD).

22. The apparatus of claim 19, wherein the information specifies the SL-PRS resource configuration on at least one of a slot portion level or a slot level.

23. The apparatus of claim 19, wherein the SL-PRS resource configuration is independent for each of the plurality of slot portions of the slot.

24. The apparatus of claim 1, wherein the at least one processor is configured to:
output sidelink control information (SCI) for transmission to a receive user equipment (UE).

25. The apparatus of claim 24, wherein the SCI comprises information related to a SL-PRS resource configuration for each of the plurality of slot portions of the slot.

26. The apparatus of claim 25, wherein the information specifies the SL-PRS resource configuration on at least one of a slot portion level or a slot level.

27. The apparatus of claim 25, wherein the information is an indication of one or more slot portions of the plurality of slot portions of the slot that are enabled or disabled for one or more SL-PRS resources.

28. The apparatus of claim 1, wherein the apparatus is configured as a user equipment (UE), and further comprising:
at least one transceiver configured to receive the resource block.

29. A method for performing sidelink positioning at a user equipment (UE), comprising:
receiving a resource block comprising a plurality of sidelink symbols in a slot, wherein the slot comprises a plurality of slot portions, a first slot portion of the plurality of slot portions comprising at least a first sidelink symbol with at least a first sidelink positioning reference signal (SL-PRS) resource and a second slot portion of the plurality of slot portions comprising at least a second sidelink symbol with at least a second SL-PRS resource; and
processing at least one SL-PRS resource in each of the plurality of slot portions of the slot.

30. An apparatus for performing sidelink positioning, comprising:
at least one memory; and
at least one processor coupled to the at least one memory, the at least one processor configured to:
generate a resource block comprising a plurality of sidelink symbols in a slot, wherein the slot includes a plurality of slot portions, each slot portion from the plurality of slot portions of the slot comprising at least one sidelink positioning reference signal (SL-PRS) resource; and
transmit the resource block to a user equipment (UE).
